(19) United States
(12) Patent Application Publication
(10) Pub. No.: US 2012/0166042 A1
(43) Pub. Date: Jun. 28, 2012

(54) SOUND OUTPUT DEVICE FOR ELECTRIC VEHICLE

(76) Inventors: Noritaka Kokido, Tokyo (JP); Takahisa Aoyagi, Tokyo (JP); Takuya Taniguchi, Tokyo (JP); Asako Omote, Tokyo (JP)

(21) Appl. No.: 13/394,504

(22) PCT Filed: Dec. 11, 2009
(86) PCT No.: PCT/JP2009/006806

§ 371 Date: Mar. 6, 2012

(51) Int. Cl. B60Q 5/00

(52) U.S. Cl. 701/36

(57) ABSTRACT

Disclosed is a sound output device for electric vehicle including a sound producing unit 11 for producing a sound, an information acquiring unit 12 for acquiring state information about the state of a vehicle or surroundings information about surroundings of the vehicle, and a control unit 13 for controlling a sound volume and an output direction of the sound produced by the sound producing unit 11 according to the vehicle state information or the surroundings information acquired by the information acquiring unit 12 to output the sound to outside the vehicle. Therefore, the sound output device for electric vehicle makes it easy for pedestrians and passengers each riding on a vehicle, such as a light vehicle or a motorbike, to hear the sound produced thereby, or can prevent neighboring residents from being put into an unpreferable situation.

### FIELD OF THE INVENTION

The present invention relates to a sound output device for electric vehicle suitable for use in an electric vehicle and a hybrid car using electric power, as a travel driving source, instead of an engine.

### BACKGROUND OF THE INVENTION

Electric vehicles and hybrid cars use electric motors which produce less sound than engines as a travel driving source. Therefore, there are cases in which pedestrians or passengers each riding on a vehicle, such as a light vehicles or a motorbike, do not notice the approach of such an electric vehicle or a hybrid car, and this causes an accident.

As a solution to this problem, patent references 1 and 2 disclose methods of arranging speakers in an outer portion of an electric vehicle, and producing a sound to notify the approach of the electric vehicle, for example.

According to the technique disclosed by patent reference 1, a warning sound is produced according to the speed of an electric vehicle, while according to the technique disclosed by patent reference 2, an electric vehicle makes a pseudo engine sound only when traveling along a road or in an area which the vehicle should switch its driving force to its motor according to map information used for car navigation.

### RELATED ART DOCUMENT

### Patent Reference

Patent reference 1: Japanese Unexamined Patent Application Publication No. Hei 11-27810
Patent reference 2: Japanese Unexamined Patent Application Publication No. 2004-153929

### SUMMARY OF THE INVENTION

According to either of the techniques disclosed by patent references 1 and 2, an electric vehicle outputs a warning sound or a pseudo sound implying an engine's operation toward a certain direction regardless of the surroundings of the electric vehicle and facilities in an area surrounding the vehicle. Therefore, there occurs a situation in which the produced sound is heard faintly depending on the environment in which the vehicle is traveling, and it is hard for a pedestrian and a passenger riding on a vehicle, such as a light vehicle or a motorbike, whom the vehicle is approaching to hear the produced sound.

Furthermore, because the sound is produced with a sound volume larger than needed in some cases, the produced sound is not preferable because the sound causes inconvenience to neighboring residents. In addition, because the sound is outputted in all directions regardless of the traveling directions of pedestrians and passengers each riding on a vehicle, such as a light vehicle or a motorbike, the outputted sound may make neighboring residents feel bad.

The present invention is made in order to solve the above-mentioned problems, and it is therefore an object of the present invention to provide a sound output device for electric vehicle that can effectively notify the approach of a vehicle to pedestrians and so on by controlling either a sound volume or an output direction according to the state of the vehicle or the surroundings of the vehicle.

In accordance with the present invention, there is provided a sound output device for electric vehicle including: a sound producing unit for producing a sound; an information acquiring unit for acquiring state information about a state of a vehicle or surroundings information about surroundings of the vehicle; and a control unit for controlling a sound volume or an output direction of the sound produced by the above-mentioned sound producing unit according to the vehicle state information or the surroundings information acquired by the above-mentioned information acquiring unit to output the sound to outside the vehicle.

Because the sound output device for electric vehicle in accordance with the present invention can notify the approach of the vehicle to pedestrians and so on effectively by controlling the sound volume according to the state or the surroundings of the vehicle, the sound output device for electric vehicle in accordance with the present invention makes it easy for pedestrians and passengers each riding on a vehicle, such as a light vehicle or a motorbike, to hear the sound produced thereby, or can prevent neighboring residents from being put into an unpreferable situation.

### BRIEF DESCRIPTION OF THE FIGURES

FIG. 1 is a block diagram showing the structure of a sound output device for electric vehicle in accordance with Embodiment 1 of the present invention;

FIG. 2 is a flow chart showing an initialization operation of the sound output device for electric vehicle in accordance with Embodiment 1 of the present invention;

FIG. 3 is a flowchart showing a fundamental operation of the sound output device for electric vehicle in accordance with Embodiment 1 of the present invention;

FIG. 4 is a block diagram showing the structure of a sound output device for electric vehicle in accordance with Embodiment 2 of the present invention;

FIG. 5 is a flowchart showing a fundamental operation of the sound output device for electric vehicle in accordance with Embodiment 2 of the present invention;

FIG. 6 is a block diagram showing the structure of a sound output device for electric vehicle in accordance with Embodiment 3 of the present invention;

FIG. 7 is a flowchart showing a fundamental operation of the sound output device for electric vehicle in accordance with Embodiment 3 of the present invention;

FIG. 8 is a block diagram showing the structure of a sound output device for electric vehicle in accordance with Embodiment 4 of the present invention;

FIG. 9 is a flowchart showing a fundamental operation of the sound output device for electric vehicle in accordance with Embodiment 4 of the present invention;

FIG. 10 is a block diagram showing the structure of a sound output device for electric vehicle in accordance with Embodiment 5 of the present invention;

FIG. 11 is a flow chart showing a fundamental operation of the sound output device for electric vehicle in accordance with Embodiment 5 of the present invention;

FIG. 12 is a block diagram showing the structure of a sound output device for electric vehicle in accordance with Embodiment 6 of the present invention;

FIG. 13 is a flowchart showing a fundamental operation of the sound output device for electric vehicle in accordance with Embodiment 6 of the present invention;

FIG. 14 is a block diagram showing the structure of a sound output device for electric vehicle in accordance with Embodiment 7 of the present invention;

FIG. 15 is a view showing an example of a sound output direction in the sound output device for electric vehicle in accordance with Embodiment 7 of the present invention;

FIG. 16 is a flow chart showing a fundamental operation of the sound output device for electric vehicle in accordance with Embodiment 7 of the present invention;

FIG. 17 is a block diagram showing the structure of a sound output device for electric vehicle in accordance with Embodiment 8 of the present invention;

FIG. 18 is a flow chart showing a fundamental operation of the sound output device for electric vehicle in accordance with Embodiment 8 of the present invention;

FIG. 19 is a block diagram showing the structure of a sound output device for electric vehicle in accordance with Embodiment 9 of the present invention;

FIG. 20 is a flow chart showing a fundamental operation of the sound output device for electric vehicle in accordance with Embodiment 9 of the present invention;

FIG. 21 is a block diagram showing the structure of a sound output device for electric vehicle in accordance with Embodiment 10 of the present invention;

FIG. 22A is a flow chart showing a fundamental operation (1) of the sound output device for electric vehicle in accordance with Embodiment 10 of the present invention;

FIG. 22B is a flow chart showing the fundamental operation (1) of the sound output device for electric vehicle in accordance with Embodiment 10 of the present invention;

FIG. 23A is a flow chart showing a fundamental operation (2) of the sound output device for electric vehicle in accordance with Embodiment 10 of the present invention; and

FIG. 23B is a flow chart showing the fundamental operation (2) of the sound output device for electric vehicle in accordance with Embodiment 10 of the present invention.

### EMBODIMENTS OF THE INVENTION

Hereafter, in order to explain this invention in greater detail, the preferred embodiments of the present invention will be described with reference to the accompanying drawings. Embodiment 1.

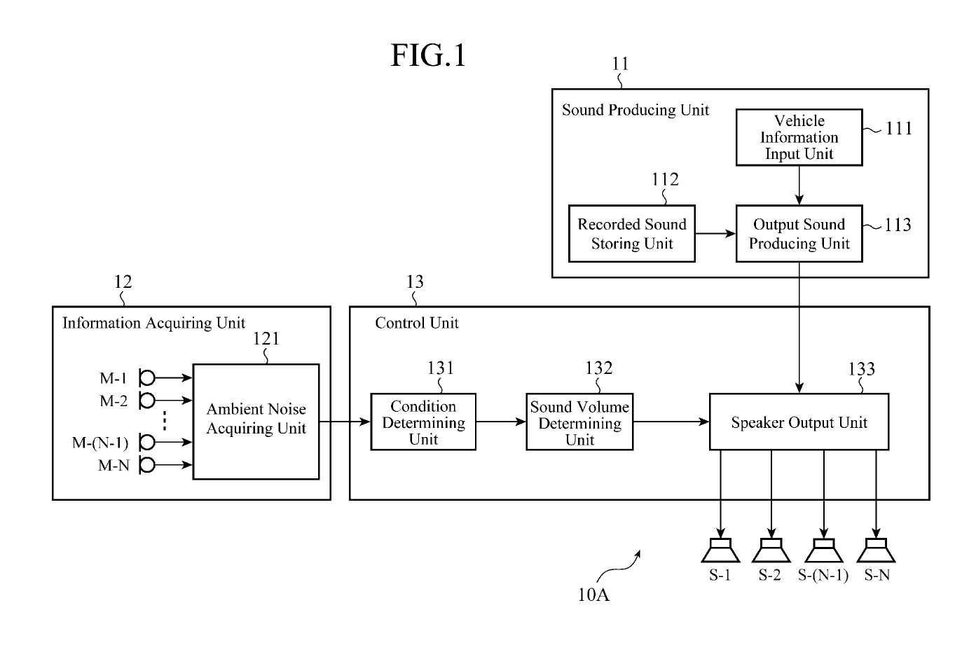

FIG. 1 is a block diagram showing the structure of a sound output device for electric vehicle 10A in accordance with Embodiment 1 of the present invention.

Referring to FIG. 1, the sound output device for electric vehicle 10A in accordance with Embodiment 1 of the present invention is comprised of a sound producing unit 11, an information acquiring unit 12, and a control unit 13.

The sound producing unit 11 has a function of producing a sound. To this end, the sound producing unit 11 includes a vehicle information input unit 111, a recorded sound storing unit 112, and an output sound producing unit 113.

The vehicle information input unit 111 is a block which serves as a user interface for enabling the driver of a vehicle to select the size or the type of the vehicle at the time of initial settings (at the time of the first time use of the sound output device for electric vehicle 10A), and notifies vehicle information including the type or the size selectively inputted as above to the output sound producing unit 113. The output sound producing unit 113 selects a sound from among recorded informing sounds which are recorded in advance and stored in the recorded sound storing unit 112 according to the vehicle information which is selectively inputted by the vehicle information input unit 111, and furnishes the sound signal to a speaker output unit 133 of the control unit 13 which will be mentioned later.

Although it is preferable that the sound outputted by the output sound producing unit 113 which is one informing sound recorded in advance and stored in the recorded sound storing unit 112 is an engine sound which makes it easy to recognize that the engine sound is produced by a vehicle, a sound for calling attention, a natural sound, or the like can be used instead of the engine sound. Furthermore, when producing a sound for the second and subsequent times, the output sound producing unit furnishes the sound signal which it has selected for the first time to the speaker output unit 133 as an output sound signal unless the above-mentioned vehicle information is set up again via the vehicle information input unit 111. When no initial settings are made, the outputted sound can be set to the default of a pseudo engine sound of a sedan having a typical piston displacement.

The information acquiring unit 12 has a function of acquiring state information about the state of the vehicle and surroundings information about the surroundings of the vehicle. In this embodiment, in order to acquire an outside noise which is surroundings information, the information acquiring unit includes microphones (M−1, M−2, . . . , M−(N−1), and M−N) for acquisition of an outside noise, and an ambient noise acquiring unit 121. The state information includes information showing whether or not the lights stay illuminated, information showing the operating state of the wiper, the type of the vehicle, and the size of the vehicle. The surroundings information includes outside noise information, vehicle position information and map information (traveling road information, vehicle surroundings facility information), current time information, image shot information, and distance information about the distance to an object.

The ambient noise acquiring unit 121 captures a noise in the outside of the vehicle which is collected by each of the N microphones (M−1, M−2, . . . , M−(N−1), and M−N) installed in the front bumper and so on of the vehicle, A/D (Analog/Digital) converts the noise into a digital signal, and outputs this digital signal to a condition determining unit 131 of the control unit 13 which will be mentioned later.

The control unit 13 has a function of controlling the sound volume of the sound produced by the sound producing unit 11 according to the vehicle state information or the surroundings information which is acquired by the information acquiring unit 12, and outputting the sound to outside the vehicle. To this end, the control unit includes the condition determining unit 131, a sound volume determining unit 132, and the speaker output unit 133.

The condition determining unit 131 determines a noise level from the outside noise captured by the ambient noise acquiring unit 121 of the information acquiring unit 12, and informs the noise level to the sound volume determining unit 132. The noise level notified to the sound volume determining unit is information showing the degree of influence of the surrounding noise from the surroundings of the vehicle on the pseudo sound which this sound output device outputs to outside the vehicle, for example. More specifically, an upper limit threshold and a lower limit threshold are disposed for the determination of the noise level in advance, and the noise is classified as level 10 when the noise has a level higher than the upper limit threshold while the noise is classified as level 1 when the noise has a level lower than the lower limit threshold. When the noise has a level falling within the range from the upper limit threshold to the lower limit threshold, the noise is classified as level 2, . . . , or level 9 according to its level. When the noise has a level higher than the upper limit threshold, because increase in the volume of the pseudo sound which the sound output device outputs to outside the vehicle according to the high surrounding noise level imposes an inconvenience to the surroundings of the vehicle, and also makes passengers in the inner space of the vehicle cabin feel bad, the sound output device classifies the noise level as level 10 uniformly, and sets the sound volume of the pseudo sound which the sound output device outputs to outside the vehicle to a predetermined maximum sound volume to keep it at the constant volume. Similarly, when the noise has a level lower than the lower limit threshold, because excessive decrease in the volume of the pseudo sound which the sound output device outputs to outside the vehicle according to the low surrounding noise level causes a possibility that neither pedestrians nor passengers each riding on a vehicle, such as a light vehicle or a motorbike, notice the approach of the vehicle, the sound output device classifies the noise level as level 1, and sets the sound volume of the pseudo sound which the sound output device outputs to outside the vehicle to a predetermined minimum sound volume to keep it at the constant volume. When the noise has a level falling within the range from the lower limit threshold to the upper limit threshold, the sound output device controls the sound volume in such a way that the sound volume increases from the predetermined minimum sound volume to the predetermined maximum sound volume with increase in the noise level.

The sound volume determining unit 132 determines the sound volume of the sound which is outputted from each of speaker units (S−1, S−2, . . . , S−(N−1), and S−N) which are externally connected to the speaker output unit 133 according to the noise level informed thereto from the condition determining unit 131. The speaker output unit 133 amplifies an output signal furnished thereto from the output sound producing unit 113 of the sound producing unit 11 in order to output the output signal at the sound volume determined by the sound volume determining unit 132 from the speaker units (S−1, S−2, . . . , S−(N−1), and S−N), and drives the speaker units (S−1, S−2, . . . , S−(N−1), and S−N).

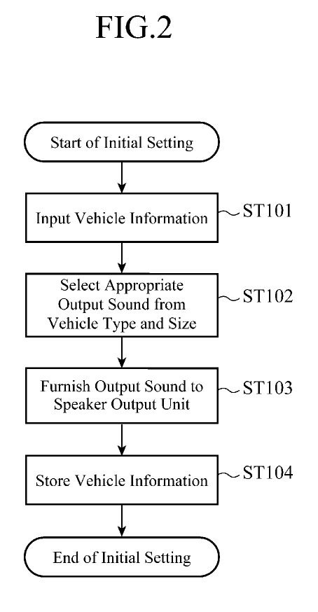

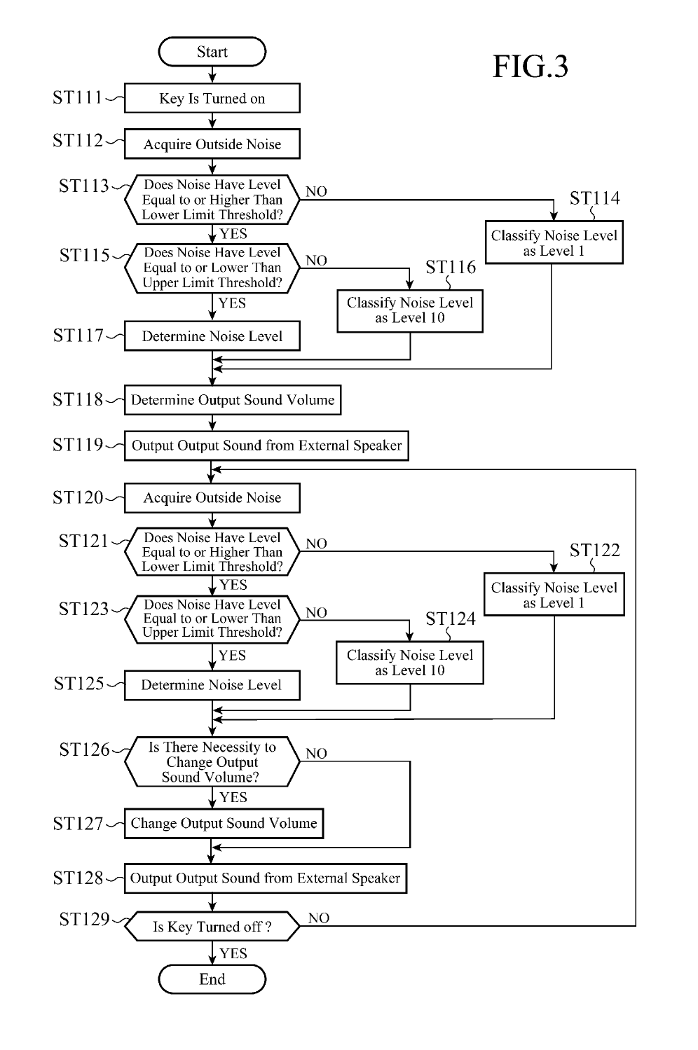

FIGS. 2 and 3 are flow charts showing operations of the sound output device for electric vehicle 10A in accordance with Embodiment 1 of the present invention, and show an initialization operation (FIG. 2) and a fundamental operation (FIG. 3), respectively.

Hereafter, the operations of the sound output device for electric vehicle 10A of FIG. 1 will be explained in detail with reference to FIGS. 2 and 3.

Explaining the initialization operation with reference to FIG. 2, when the sound output device for electric vehicle 10A is used for the first time, the driver sets up vehicle information by using the sound producing unit 11 first. Through this operation, the driver can make a setting to cause the sound output device to output a sound suitable for the vehicle information, such as the size or the type of the vehicle. As an alternative, the user is allowed to select his or her favorite sound to cause the sound output device to output the sound suited to the user's taste. More specifically, the driver inputs the information about the size or the type of the vehicle by operating the vehicle information input unit 111 (step ST101). In this embodiment, the driver uses a user interface which is provided as the vehicle information input unit 111 by either a display for car navigation or car audio or a remote controller to input the vehicle information.

When the vehicle information is inputted, the output sound producing unit 113 selects an appropriate output sound according to the vehicle information from the recorded sound storing unit 112 (step ST102), and furnishes the output sound signal to the speaker output unit 133 of the control unit 13 (step ST103) and also stores the vehicle information in a built-in memory (not shown) (step ST104). When producing a sound for the second and subsequent times, the output sound producing unit 113 furnishes the same sound signal to the speaker output unit 133 unless the above-mentioned vehicle information is set up again.

The initialization operation is completed after the above-mentioned process is done. Finally, the sound output device for electric vehicle 10A can change the tone of the output sound according to the vehicle type such as the size or the type of the vehicle, and can therefore make it possible for pedestrians and so on to determine the type of the approaching vehicle easily from the sound suitable for the size or the type of the vehicle.

Explaining the fundamental operation with reference to FIG. 3, when the driver performs an operation of turning on an ignition key to cause the vehicle to supply accessories (ACC) electric power to the vehicle first (step ST111), each of the microphones (M−1, M−2, . . . , M−(N−1), and M−N) for acquisition of an outside noise, as the information acquiring unit 12, attached to parts of the vehicle collects a noise occurring in the outside of the vehicle, and the ambient noise acquiring unit 121 captures this noise and outputs this noise signal to the condition determining unit 131 of the control unit 13 (step ST112).

The condition determining unit 131 compares captured noise with each of the predetermined upper and lower limit thresholds. At this time, the condition determining unit determines whether or not the noise has a level falling within the range from the lower limit threshold to the upper limit threshold first (steps ST113 and ST115). When the noise has a level equal to or higher than the lower limit threshold (when “YES” in step ST113) and equal to or lower than the upper limit threshold (when “YES” in step ST115), the condition determining unit classifies the noise as level 2, . . . , or level 9 according to the level of the noise (step ST117). In contrast, when the noise has a level lower than the lower limit threshold (when “NO” in step ST113), the condition determining unit classifies the noise as level 1 (step ST114), and when the noise has a level higher than the upper limit threshold (when “NO” in step ST115), the condition determining unit classifies the noise as level 10 (step ST116).

The noise level determined by the condition determining unit 131 is notified to the sound volume determining unit 132, and the sound volume determining unit 132 determines the sound volume of the sound which the sound output device outputs according to the noise level (step ST118). The sound volume determined by the sound volume determining unit 132 is informed to the speaker output unit 133, and the speaker output unit 133 amplifies the output signal furnished thereto from the output sound producing unit 113 of the sound producing unit 11 and drives the speaker units (S−1, S−2, . . . , S−(N−1), and S−N) which are externally connected thereto to output the output signal at the sound volume determined by the sound volume determining unit 132 (step ST119).

As mentioned above, after the output sound is produced from the speaker units (S−1, S−2, . . . , S−(N−1), and S−N), by using the ambient noise acquiring unit 121, the information acquiring unit 12 always acquires the outside noise which it has collected by using the microphones (M−1, M−2, . . . , M−(N−1), and M−N) for acquisition of an outside noise (step ST120). The control unit 13 which has received this outside noise determines the noise level of the noise which the condition determining unit 131 has captured (steps ST121 to ST125). The noise level determined by the condition determining unit 131 is notified to the sound volume determining unit 132, and the sound volume determining unit 132 determines the sound volume from the noise level. When carrying out this determination of the sound volume, the sound volume determining unit 132 compares the sound volume determined by the condition determining unit 131 with the sound volume of the output sound which the sound output device has outputted until now (step ST126). When there is a necessity to change the sound volume (when “YES” in step ST126), the sound volume determining unit notifies a change of the sound volume to the speaker output unit 133 (step ST127).

When receiving a notification of a change of the sound volume, the speaker output unit 133 changes the amplification factor thereof in such a way that the output signal furnished thereto from the output sound producing unit 113 of the sound producing unit 11 has the desired sound volume, and drives the speaker units (S−1, S−2, . . . , S−(N−1), and S−N) which are externally connected thereto (step ST128). When the driver performs an operation of turning off the ignition key to stop the supply of the ACC electric power (when “YES” in step ST129), the sound output device stops the sound output from each of the speaker units (S−1, S−2, . . . , S−(N−1), and S−N), and ends the series of above-mentioned processes.

In the sound output device for electric vehicle 10A in accordance with above-mentioned Embodiment 1, when the outside noise which is surroundings information about the surroundings of the vehicle which is acquired by the information acquiring unit 12 (ambient noise acquiring unit 121) has a level falling within the range from the preset upper limit threshold to the preset lower limit threshold, the control unit 13 controls the sound volume of the output sound in such a way that the sound volume increases every time when the outside noise increases in level, and otherwise controls the sound volume in such away that the sound volume is kept constant. Therefore, when the vehicle is traveling in an area in which it is hard to hear the output sound from the vehicle easily, the sound output device for electric vehicle controls the sound volume of the output sound in such a way that the sound volume becomes large, while when the vehicle is traveling in an area in which it is easy to hear the output sound from the vehicle, the sound output device for electric vehicle controls the sound volume of the output sound in such a way that the output sound has a volume that is not larger than necessary.

As a result, the sound output device for electric vehicle makes it possible for pedestrians and passengers each riding on a vehicle, such as a light vehicle or a motorbike, to easily recognize the approach of the vehicle in an area in which the outside noise is high in level and it is hard to hear the output sound easily, and can further control the sound volume of the output sound in such a way that the output sound has a volume that is not larger than necessary in an area in which the outside noise is low in level and it is easy to hear the output sound. Therefore, the sound output device for electric vehicle can provide an environment preferable for passengers riding on the vehicle and neighboring residents.

### Embodiment 2

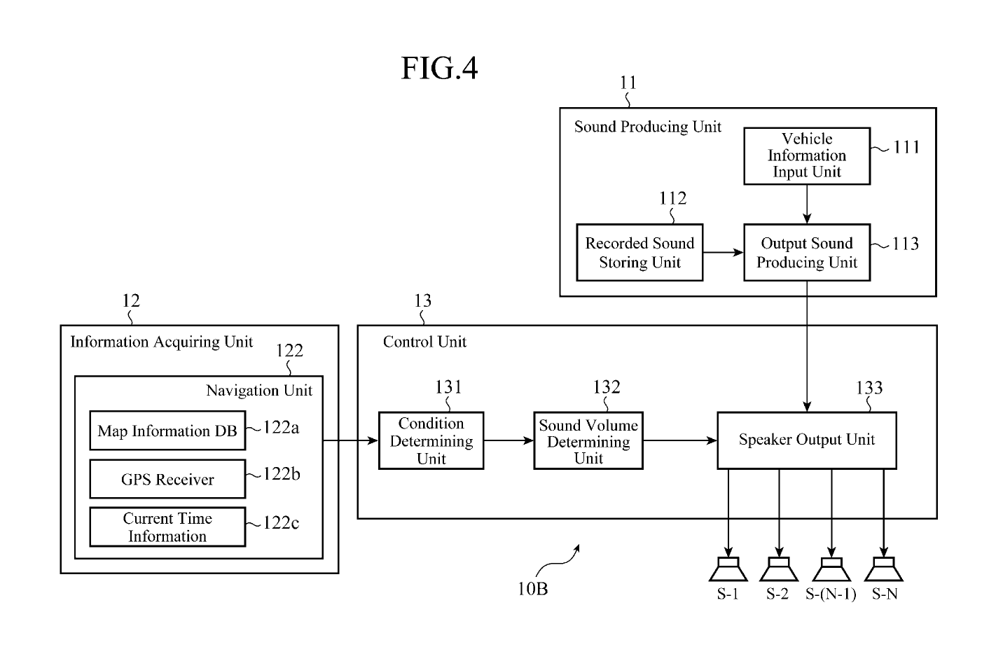

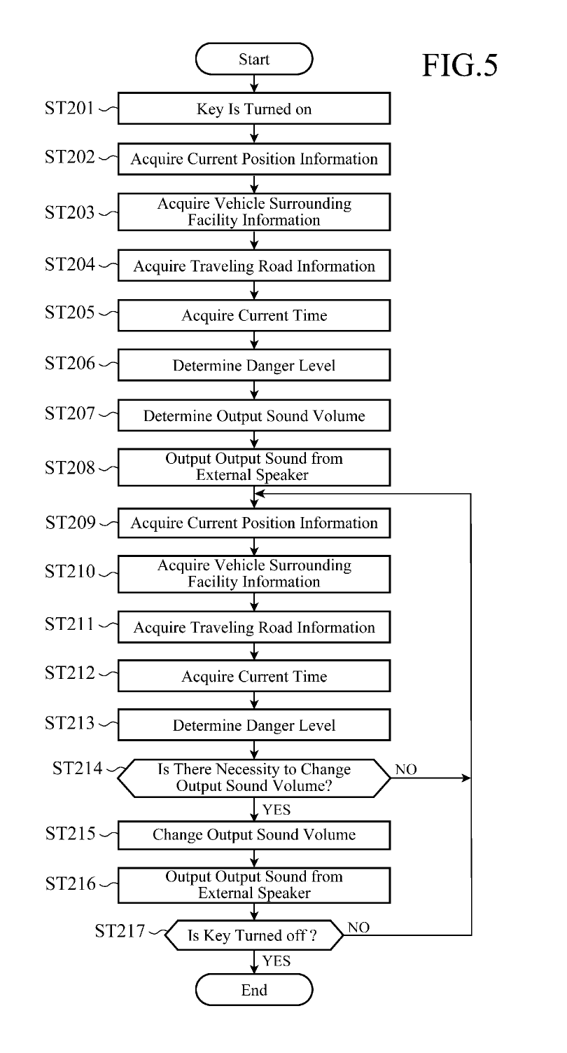

FIG. 4 is a block diagram showing the structure of a sound output device for electric vehicle 10B in accordance with Embodiment 2 of the present invention, and FIG. 5 is a flow chart showing a fundamental operation of the sound output device for electric vehicle 10B in accordance with Embodiment 2 of the present invention.

Referring to FIG. 4, the sound output device for electric vehicle differs from that in accordance with Embodiment 1 shown in FIG. 1 in that the ambient noise acquiring unit 121 which constructs the information acquiring unit 12 in Embodiment 1 is replaced by a navigation unit 122. The other structural components of the sound output device for electric vehicle are the same as those in accordance with Embodiment 1.

As well known, the navigation unit 122 includes a map information DB 122a in which road information (intersections, points of frequent traffic accidents, road widths, road types, blind curves, etc.) and facility information (facility information about facilities such as schools and shopping centers, addresses, latitudes and longitudes, etc.) are recorded, and a GPS receiver 122b for receiving radio waves emitted from GPS (Global Positioning System) satellites to measure a vehicle position (current position), and for acquiring current time information 122c, and furnishes these pieces of information to a condition determining unit 131 of a control unit 13.

The condition determining unit 131 determines a degree level for the road along which the vehicle is travelling or the vehicle's surrounding environment according to the current position information and map information (the road information about the road along which the vehicle is travelling and the facility information about facilities in the surroundings) which are captured thereby. The information about the danger level determined by the condition determining unit is sent to a sound volume determining unit 132.

For example, the danger level notified to the sound volume determining unit is information showing the degree of danger of a location in the road or the surrounding environment which the condition determining unit has determined is dangerous, such as an area close to a school, a shopping district, a pedestrian crossing, an intersection, a point of frequent traffic accidents, a blind curve, an area in which many pedestrians walk, an area in which there is a high possibility that persons run into the road, an area in which numerous accidents have occurred, or an area under low visibility conditions. The condition determining unit classifies a location where the degree of danger is the highest as level 10 and sets the sound volume of a sound which the sound output device outputs to outside the vehicle to a predetermined maximum sound volume to keep it at the constant volume, while the condition determining unit classifies a location where the degree of danger is the lowest as level 1 and sets the sound volume of the sound which the sound output device outputs toward outside the vehicle to a predetermined minimum sound volume to keep it at the constant volume. When the degree of danger falls within the range from the highest degree to the lowest degree, the degree of danger is classified as level 2, . . . , or level 9 according to the degree of danger. The sound output device controls the sound volume in such a way that the sound volume increases from the predetermined minimum sound volume to the predetermined maximum sound volume with increase in the danger level. Because when the vehicle is travelling along a highway, the sound output device does not have to output any sound because there are neither pedestrians nor passengers each riding on a light vehicle on the highway, the sound output device classifies the danger level as level 0.

The sound volume determining unit 132 determines the sound volume of the sound which the sound output device outputs from the information showing the notified danger level, and informs the sound volume to a speaker output unit 133. Because the vehicle is in an environment in which the vehicle does not have to output any sound when the danger level is classified as level 0, the sound output device mutes the output sound.

The speaker output unit 133 amplifies an output signal furnished thereto from an output sound producing unit 113 of a sound producing unit 11 in order to output the output signal at the sound volume determined by the sound volume determining unit 132 from speaker units (S−1, S−2, . . . , S−(N−1), and S−N) which are externally connected thereto, and drives the speaker units (S−1, S−2, . . . , S−(N−1), and S−N).

Explaining the operation with reference to FIG. 5, when the driver performs an operation of turning on an ignition key to cause the vehicle to supply ACC electric power to the vehicle first (step ST201), the condition determining unit 131 of the control unit 13 captures the current position information and the map information (the information about the road along which the vehicle is travelling and the facility information about facilities in the surroundings) from the navigation unit 122 of the information acquiring unit 12 (steps ST202 to ST205), and determines the danger level (step ST206).

The danger level determined by the condition determining unit 131 is informed to the sound volume determining unit 132. The sound volume determining unit 132 sets the sound volume of the sound which the sound output device outputs to outside the vehicle to the predetermined maximum sound volume to keep it at the constant volume when the danger level is classified as level 10 which is the highest, while the sound volume determining unit sets the sound volume of the sound which the sound output device outputs to outside the vehicle to the predetermined minimum sound volume to keep it at the constant volume when the danger level is classified as level 1 which is the lowest. When the danger level is classified as level 2, . . . , or level 9, the sound output device determines the sound volume in such a way that the sound volume increases from the predetermined minimum sound volume to the predetermined maximum sound volume with increase in the danger level (step ST207). The sound volume determined by the sound volume determining unit 132 is informed to the speaker output unit 133, and the speaker output unit 133 amplifies the output signal furnished thereto from the output sound producing unit 113 of the sound producing unit 11 and drives the speaker units (S−1, S−2, . . . , S−(N−1), and S−N) which are externally connected thereto to output the output signal at the sound volume determined by the sound volume determining unit 132, and outputs the pseudo engine sound (step ST208).

After outputting the pseudo engine sound having the predetermined sound volume from the speaker units (S−1, S−2, . . . , S−(N−1), and S−N), the navigation unit 122 of the information acquiring unit 12 acquires the current position information and the map information (the information about the road along which the vehicle is travelling and the facility information about facilities in the surroundings) all the time, and sends these pieces of information to the condition determining unit 131 of the control unit 13 (steps ST209 to ST212). The condition determining unit 131 which has received these pieces of information determines the danger level (step ST213).

Information showing the danger level determined by the condition determining unit 131 is sent to the sound volume determining unit 132, and the sound volume determining unit 132 determines the sound volume of the sound which the sound output device outputs from the danger level. The sound volume determining unit 132 also compares the sound volume determined thereby with the sound volume of the output sound which the sound output device has outputted until now (step ST214), and, when there is a necessity to change the sound volume (when “YES” in step ST214), the sound volume determining unit notifies a change of the sound volume to the speaker output unit 133 (step ST215). When receiving a notification of a change of the sound volume, the speaker output unit 133 changes the amplification factor thereof in such a way that the output signal furnished thereto from the output sound producing unit 113 of the sound producing unit 11 has the desired sound volume, and drives each of the speaker units (S−1, S−2, . . . , S−(N−1), and S−N) (step ST216). When the driver then, in step ST217, performs an operation of turning off the ignition key to disconnect the sound output device from the ACC electric power supply (when “YES” in step ST217), the sound output device stops the output of the pseudo sound from each of the speaker units (S−1, S−2, . . . , S−(N−1), and S−N), and ends the series of above-mentioned processes.

The information acquiring unit can also acquire the current time information from the navigation unit 122 in addition to the current position information and the map information, and the condition determining unit 131 of the control unit 13 can determine the danger level from both the current time information and degree-of-danger information for each time period which is included in the map information. For example, when the vehicle is passing through a school zone, the condition determining unit classifies the degree level as a higher level during school commuting hours compared with other times of day. Also in Embodiment 2, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10B in accordance with Embodiment 2, the control unit 13 controls the sound volume according to current area information which is based on both the vehicle position information which is state information of the vehicle, and the map information which is surroundings information, which are acquired by the information acquiring unit 12 (navigation unit 122), thereby being able to effectively notify the approach of the vehicle to pedestrians etc.

For example, when the vehicle is traveling in an area close to a school or a shopping district, through an intersection or a point of frequent traffic accidents, along a road having a narrow width or a blind curve, in an area in which many pedestrians walk, an area in which there is a high possibility that persons run into the road, an area in which numerous accidents have occurred, or an area under low visibility conditions, the sound output device for electric vehicle increases its output sound volume to make it easy for pedestrians and so on to notice the approach of the vehicle. Because the sound output device for electric vehicle can determine whether or not the vehicle is travelling during nighttime hours by using the current time information acquired from the navigation unit 122, the sound output device can also provide consideration to neighboring residents by, for example, reducing the output sound volume when the vehicle is travelling during nighttime hours by using this information in addition to the above-mentioned facility information.

### Embodiment 3

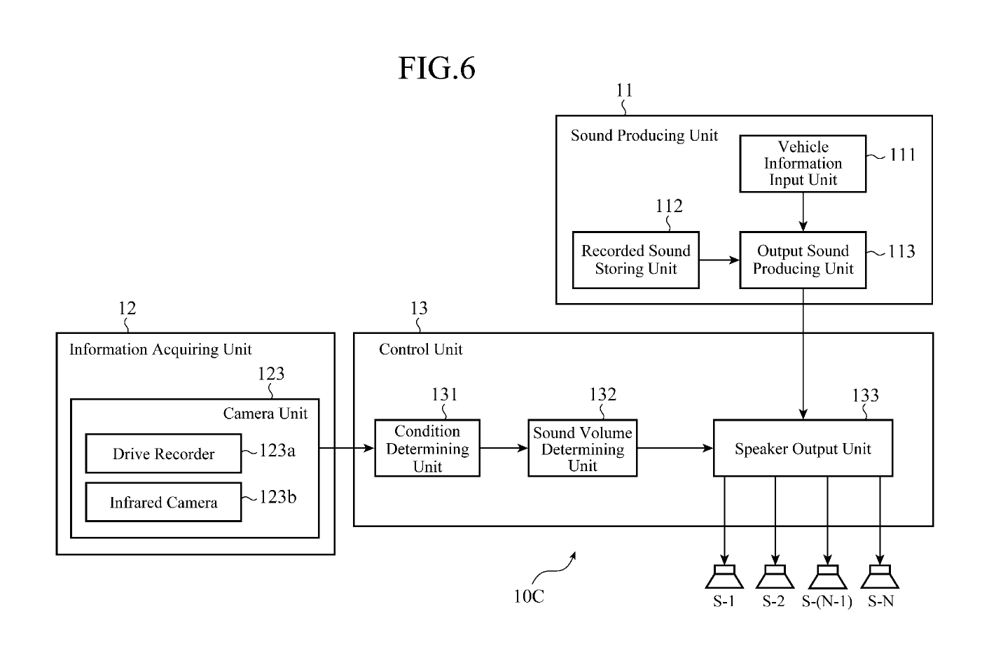

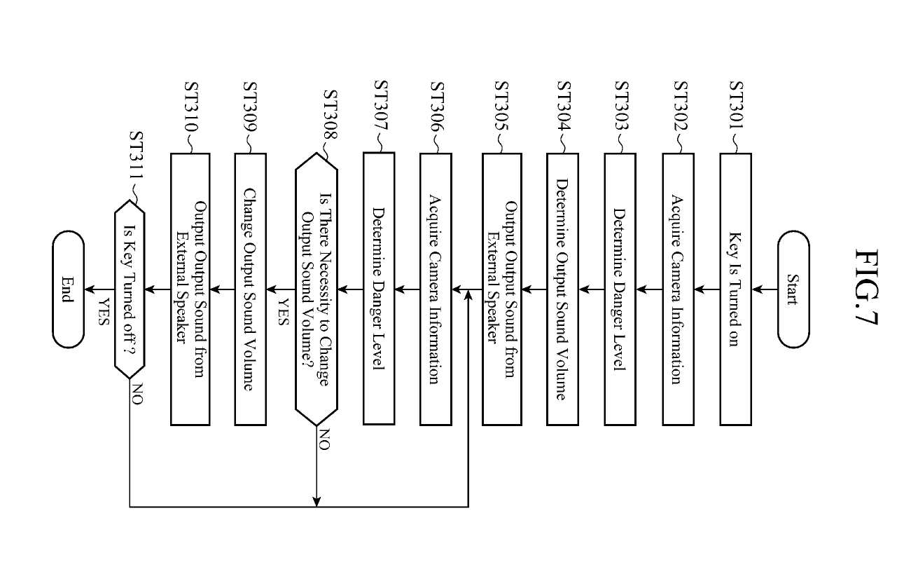

FIG. 6 is a block diagram showing the structure of a sound output device for electric vehicle 10C in accordance with Embodiment 3 of the present invention, and FIG. 7 is a flow chart showing a fundamental operation of the sound output device for electric vehicle 10C in accordance with Embodiment 3 of the present invention.

Referring to FIG. 6, the sound output device for electric vehicle differs from that in accordance with Embodiment 2 shown in FIG. 4 in that the navigation unit 122 which constructs the information acquiring unit 12 in Embodiment 2 is replaced by a camera unit 123. The other structural components are the same as those in accordance with Embodiment 2. The camera unit 123 is cameras mounted inside and outside the vehicle, for capturing images of an area in front of, areas on the right and left sides of, and an area in the back of the vehicle, and includes a drive recorder 123a and an infrared camera 123b.

As well known, when an accident has occurred or sudden acceleration or deceleration which likely leads to an accident has occurred, the drive recorder 123a records an image and travel data which are acquired before and behind such an event has occurred, and the infrared camera 123b has a light source for emitting a near infrared ray, and can capture an image during nighttime hours. The camera unit 123 has only to include either one of the drive recorder 123a and the infrared camera 123b. As an alternative, the camera unit can be a normal in-vehicle camera.

The camera unit 123 which constructs the information acquiring unit 12 captures an image of an area extending in the traveling direction of the vehicle by using the drive recorder 123a, the infrared camera 123b, or the like, and sends the image to a condition determining unit 131 which constructs a control unit 13.

The condition determining unit 131 performs an image analysis on the captured image of the area extending in the traveling direction to determine the danger level of the area from both whether or not there is an object such as a person, a light vehicle or a motorbike, and the distance between the vehicle and such an object, and informs the danger level to a sound volume determining unit 132. For example, when the condition determining unit recognizes that there is an object, such as a person, a light vehicle, or a motorbike, in front of the vehicle, the danger level notified to the sound volume determining unit is information showing, as the degree of danger, how large sound volume the vehicle must output according to the distance from the vehicle to such an object. When the distance from the vehicle to an object such a person, a light vehicle or a motorbike is short and the degree of danger is the highest, the sound volume determining unit classifies the danger level as level 10 and then sets the sound volume of a sound which the sound output device outputs to outside the vehicle to a predetermined maximum sound volume to keep it at the constant volume, while when the distance from the vehicle to the object is long and the degree of danger is the lowest, the sound volume determining unit classifies the danger level as level 1 and then sets the sound volume of the sound which the sound output device outputs to outside the vehicle to a predetermined minimum sound volume to keep it at the constant volume. When the degree of danger falls within the range from the highest one to the lowest one, the danger level is classified as level 2, . . . , or level 9 according to the degree of danger. The sound output device controls the sound volume in such a way that the sound volume increases from the predetermined minimum sound volume to the predetermined maximum sound volume with increase in the danger level. When being unable to recognize that there is an object such as a person, a light vehicle, or a motorbike in front of the vehicle, the condition determining unit classifies the danger level as level 0. In this case, the sound output device does not have to output any sound. As an alternative, the sound output device can classify the danger level as level 1, and reduce the sound volume of the sound which the sound output device outputs to the minimum.

The sound volume determining unit 132 determines the sound volume of the sound which the sound output device outputs from the information sent thereto and showing the danger level, and informs the sound volume to a speaker output unit 133. Because the vehicle is in an environment in which the vehicle does not have to output any sound when the danger level is classified as level 0, the sound output device mutes the output sound.

The speaker output unit 133 amplifies an output signal furnished thereto from an output sound producing unit 113 of a sound producing unit 11 in order to output the output signal at the sound volume determined by the sound volume determining unit 132 from speaker units (S−1, S−2, . . . , S−(N−1), and S−N) which are externally connected thereto, and drives the speaker units (S−1, S−2, . . . , S−(N−1), and S−N).

Explaining the operation with reference to FIG. 7, when the driver performs an operation of turning on an ignition key to cause the vehicle to supply ACC electric power to the sound output device first (step ST301), the condition determining unit 131 of the control unit 13 captures an image of an area in the traveling direction of the vehicle from the camera unit 123 (step ST302), performs an image analysis on the captured image, and determines the danger level of the area according to the distance between such an object as a person, a light vehicle or a motorbike and the vehicle (step ST303). The danger level determined by the condition determining unit 131 is informed to the sound volume determining unit 132. The sound volume determining unit 132 sets the sound volume of the sound which the sound output device outputs to outside the vehicle to the predetermined maximum sound volume to keep it at the constant volume when the danger level is classified as level 10 which is the highest, while the sound volume determining unit sets the sound volume of the sound which the sound output device outputs to outside the vehicle to the predetermined minimum sound volume to keep it at the constant volume when the danger level is classified as level 1 which is the lowest. When the danger level is classified as level 2, . . . , or level 9, the sound output device determines the sound volume in such a way that the sound volume increases from the predetermined minimum sound volume to the maximum sound volume with increase in the danger level (step ST304). The sound volume determined by the sound volume determining unit 132 is informed to the speaker output unit 133, and the speaker output unit 133 amplifies the output signal supplied from the output sound producing unit 113 of the sound producing unit 11 and drives the speaker units (S−1, S−2, . . . , S−(N−1), S−N) which are externally connected thereto to output the output signal at the sound volume determined by the sound volume determining unit 132 (step ST305).

After outputting the pseudo sound of predetermined sound volume from the speaker unit (S−1, S−2, . . . , S−(N−1), S−N), in the information acquiring unit 12, the camera unit 123 always acquires the video of the traveling direction, and it is notifying to the condition determining unit 131 of the control unit 13 (step ST306). In response by the condition determining unit 131, it performs the degree of danger level determination (step ST307).

Information showing the degree of danger determined by the condition determining unit 131 is sent to the sound volume determining unit 132, and the sound volume determining unit 132 determines the sound volume of the sound which the sound output device outputs from the degree of danger. The sound volume determining unit 132 also compares the sound volume determined thereby with the sound volume of the output sound which the sound output device has outputted until now (step ST308), and, when there is a necessity to change the sound volume (when “YES” in step ST308), the sound volume determining unit notifies a change of the sound volume to the speaker output unit 133 (step ST309). When receiving a notification of a change of the sound volume, the speaker output unit 133 changes the amplification factor thereof in such a way that the output signal furnished thereto from the output sound producing unit 113 of the sound producing unit 11 has the desired sound volume, and drives each of the speaker units (S−1, S−2, . . . , S−(N−1), and S−N) (step ST310).

When the driver then, in step ST311, performs an operation of turning off the ignition key to disconnect the sound output device from the ACC electric power supply (when “YES” in step ST311), the sound output device stops the output of the pseudo sound from each of the speaker units (S−1, S−2, . . . , S−(N−1), and S−N).

Also in Embodiment 3, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10C in accordance with Embodiment 3, the control unit 13 controls the sound volume by detecting the approach of a target for notification from a shot image which is surroundings information about the surroundings of the vehicle, which is acquired by the information acquiring unit 12, thereby being able to effectively notify the approach of the vehicle to a pedestrian which is a target for notification, and so on. Therefore, when finding out an object, such as a pedestrian, a light vehicle or a motorbike, existing in the traveling direction of the vehicle, for example, the sound output device controls the output sound volume of the output sound in such a way that the output sound volume becomes large with decrease in the distance between the vehicle and the object, thereby making it easy for pedestrians and so on to notice the approach of the vehicle. Furthermore, when not finding out any object, such as a pedestrian, a light vehicle or a motorbike, existing in the traveling direction of the vehicle, the sound output device controls the sound volume of the output sound in such a way that the output sound has a volume that is not larger than necessary, thereby being able to prevent passengers riding on the vehicle and neighboring residents from feeling bad.

### Embodiment 4

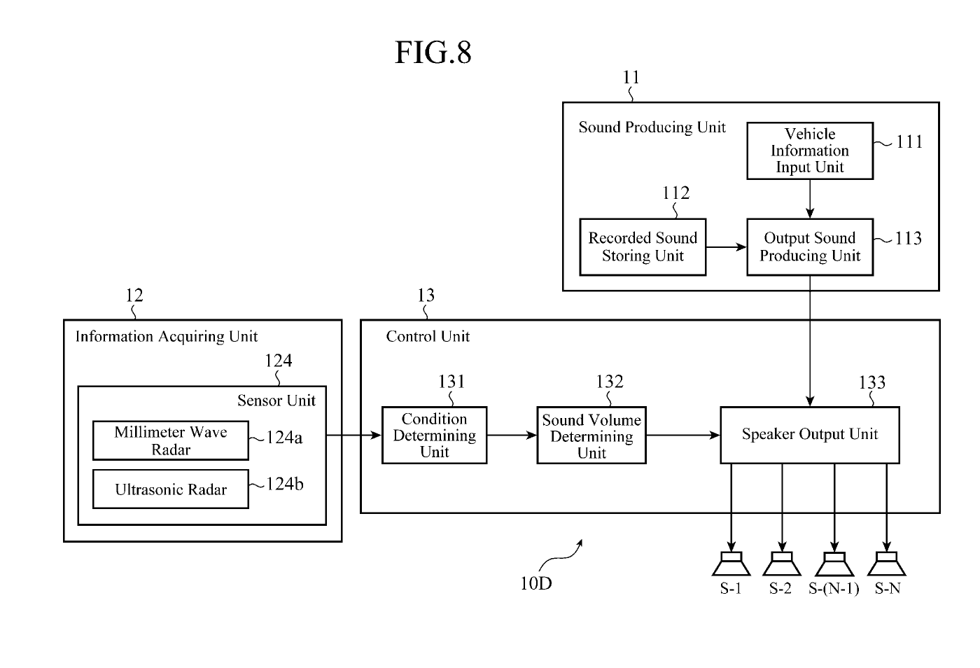

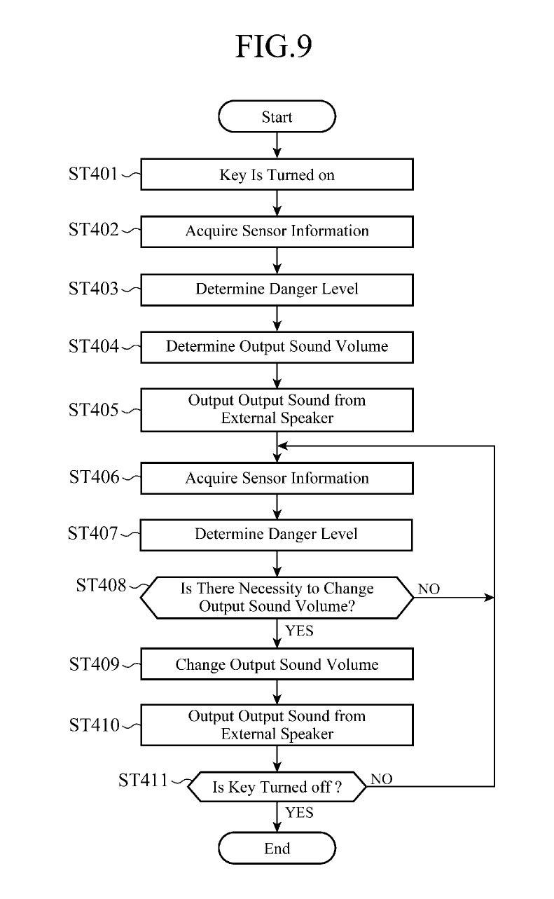

FIG. 8 is a block diagram showing the structure of a sound output device for electric vehicle 10D in accordance with Embodiment 4 of the present invention, and FIG. 9 is a flow chart showing a fundamental operation of the sound output device for electric vehicle 10D in accordance with Embodiment 4 of the present invention.

Referring to FIG. 8, the sound output device for electric vehicle differs from that in accordance with Embodiment 3 shown in FIG. 6 in that the camera unit 123 which constructs the information acquiring unit 12 in Embodiment 3 is replaced by a sensor unit 124. The other structural components of the sound output device for electric vehicle are the same as those in accordance with Embodiment 3. The sensor unit 124 includes a millimeter wave radar 124a and an ultrasonic radar 124b.

As well known, the millimeter wave radar 124a can search for an object in an area with a length of about 100 m by using a radio wave in a millimeter wave band, and the ultrasonic radar 124b is used in order to apply a sound wave having a frequency of higher than 20 kHz to an object to be searched and determine whether or not there is an object and the distance to the object from a reflected wave. At least one of these radars is mounted to each of a front portion and side portions of the vehicle, determines whether or not an object such as a pedestrian, a light vehicle, or a motorbike exists in an area surrounding the vehicle, the distance to such a target for notification, or the like, and outputs the results of the determination to a condition determining unit 131 of a control unit 13.

The condition determining unit 131 determines the danger level of the surrounding area from whether or not an object such as a pedestrian, a light vehicle, or a motorbike exists in the surrounding area and the distance between the vehicle and such a target for notification from the search results acquired by the sensor unit 124, and informs the danger level to a sound volume determining unit 132. For example, when the condition determining unit recognizes that there is an object such as a person, a light vehicle, or a motorbike in front of the vehicle, the danger level notified to the sound volume determining unit is information showing, as the degree of danger, how large sound volume the vehicle must output according to the distance from the vehicle to such an object. When the distance from the vehicle to an object such a person, a light vehicle or a motorbike is short and the degree of danger is the highest, the sound volume determining unit classifies the danger level as level 10 and then sets the sound volume of a sound which the sound output device outputs to outside the vehicle to a predetermined maximum sound volume to keep it at the constant volume, while when the distance from the vehicle to the object is long and the degree of danger is the lowest, the sound volume determining unit classifies the danger level as level 1 and then sets the sound volume of the sound which the sound output device outputs to outside the vehicle to a predetermined minimum sound volume to keep it at the constant volume. When the degree of danger falls within the range from the highest one to the lowest one, the danger level is classified as level 2, . . . , or level 9 according to the degree of danger. The sound output device controls the sound volume in such a way that the sound volume increases from the predetermined minimum sound volume to the predetermined maximum sound volume with increase in the danger level. More specifically, because the degree of danger is high when the distance between the vehicle and the object is short, the sound output device controls the sound volume in such a way that this sound volume increases. When being unable to recognize that there is an object such as a person, a light vehicle, or a motorbike in front of the vehicle, the condition determining unit classifies the danger level as level 0. In this case, the sound output device does not have to output any sound. As an alternative, the sound output device can classify the danger level as level 1, and reduce the sound volume of the sound which the sound output device outputs to the minimum.

The sound volume determining unit 132 determines the sound volume of the sound which the sound output device outputs from the information sent thereto and showing the danger level, and informs the sound volume to a speaker output unit 133. Because the vehicle is in an environment in which the vehicle does not have to output any sound when the danger level is classified as level 0, the sound output device mutes the output sound.

The speaker output unit 133 amplifies an output signal furnished thereto from an output sound producing unit 113 of a sound producing unit 11 in order to output the output signal at the sound volume determined by the sound volume determining unit 132 from speaker units (S−1, S−2, . . . , S−(N−1), and S−N) which are externally connected thereto, and drives the speaker units (S−1, S−2, . . . , S−(N−1), and S−N).

Explaining the operation with reference to FIG. 9, when the driver performs an operation of turning on an ignition key to cause the vehicle to supply ACC electric power to the sound output device first (step ST401), the condition determining unit 131 of the control unit 13 captures the search results from the sensor unit 124 (step ST402), and determines the danger level of the surrounding area according to the distance between such an object as a person, a light vehicle or a motorbike and the vehicle (step ST403). The danger level determined by the condition determining unit 131 is informed to the sound volume determining unit 132. The sound volume determining unit 132 sets the sound volume of the sound which the sound output device outputs to outside the vehicle to the predetermined maximum sound volume to keep it at the constant volume when the danger level is classified as level 10 which is the highest, while the sound volume determining unit sets the sound volume of the sound which the sound output device outputs to outside the vehicle to the predetermined minimum sound volume to keep it at the constant volume when the danger level is classified as level 1 which is the lowest. When the danger level is classified as level 2, . . . , or level 9, the sound output device determines the sound volume in such a way that the sound volume increases from the predetermined minimum sound volume to the predetermined maximum sound volume with increase in the danger level (step ST404). The sound volume determined by the sound volume determining unit 132 is informed to the speaker output unit 133, and the speaker output unit 133 amplifies the output signal supplied from the output sound producing unit 113 of the sound producing unit 11 to output the output signal at the sound volume determined by the sound volume determining unit 132, and drives each of the speaker units (S−1, S−2, . . . , S−(N−1), and S−N) to output the pseudo engine sound or the like (step ST405).

After the pseudo sound having the predetermined sound volume is outputted from the speaker units (S−1, S−2, . . . , S−(N−1), and S−N), the sensor unit 124 of the information acquiring unit 12 acquires an image of an area in the traveling direction of the vehicle, sends the image to the condition determining unit 131 of the control unit 13 (step ST406), and the condition determining unit 131 determines the danger level of the area (step ST407).

Information showing the danger level determined by the condition determining unit 131 is sent to the sound volume determining unit 132, and the sound volume determining unit 132 determines the sound volume of the sound which the sound output device outputs from the danger level. The sound volume determining unit 132 also compares the sound volume determined thereby with the sound volume of the output sound which the sound output device has outputted until now (step ST408). When determining that there is a necessity to change the sound volume (when “YES” in step ST408), the sound volume determining unit notifies a change of the sound volume to the speaker output unit 133 (step ST409). When receiving a notification of a change of the sound volume, the speaker output unit 133 changes the amplification factor thereof in such a way that the output signal furnished thereto from the output sound producing unit 113 of the sound producing unit 11 has the desired sound volume, and drives each of the speaker units (S−1, S−2, . . . , S−(N−1), and S−N) (step ST410).

When the driver then, in step ST411, performs an operation of turning off the ignition key to disconnect the sound output device from the ACC electric power supply (when “YES” in step ST411), the sound output device stops the output of the pseudo sound from each of the speaker units (S−1, S−2, . . . , S−(N−1), and S−N).

Also in Embodiment 4, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10D in accordance with Embodiment 4, the control unit 13 detects the approach of a target for notification according to the information about the distance between the vehicle and the target for notification, which is vehicle surroundings information acquired by the information acquiring unit 12 (sensor unit 124), and then controls the sound volume, thereby being able to effectively notify the approach of the vehicle to a pedestrian which is a target for notification, and so on. Therefore, when finding out an object, such as a pedestrian, a light vehicle or a motorbike, existing in the traveling direction of the vehicle, for example, the sound output device controls the output sound volume in such a way that the output sound volume becomes large with decrease in the distance between the vehicle and the object, thereby making it easy for pedestrians and so on to notice the approach of the vehicle. Furthermore, when not finding out any object, such as a pedestrian, a light vehicle or a motorbike, existing in the traveling direction of the vehicle, the sound output device controls the sound volume of the output sound in such a way that the output sound has a volume that is not larger than necessary, thereby being able to prevent passengers riding on the vehicle and neighboring residents from feeling bad.

### Embodiment 5

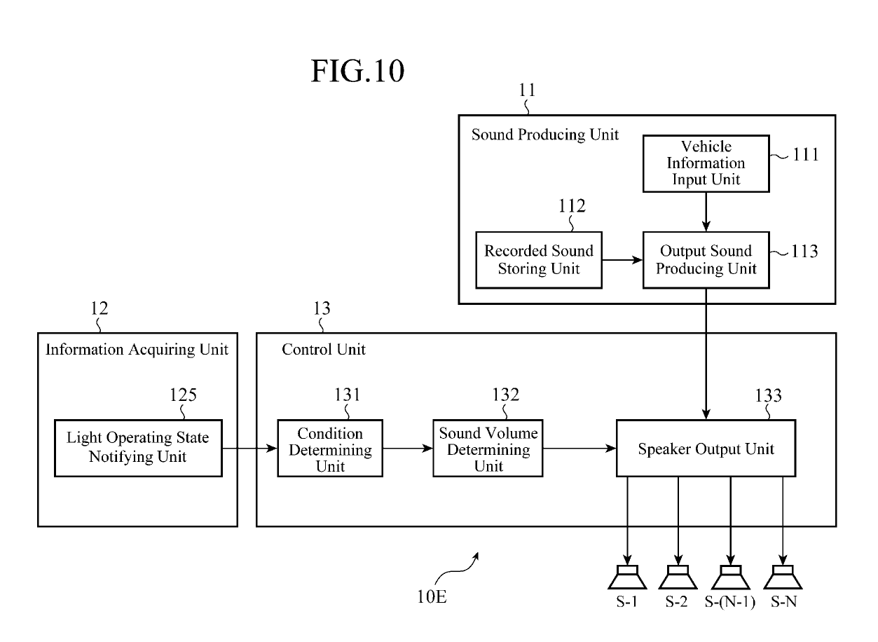

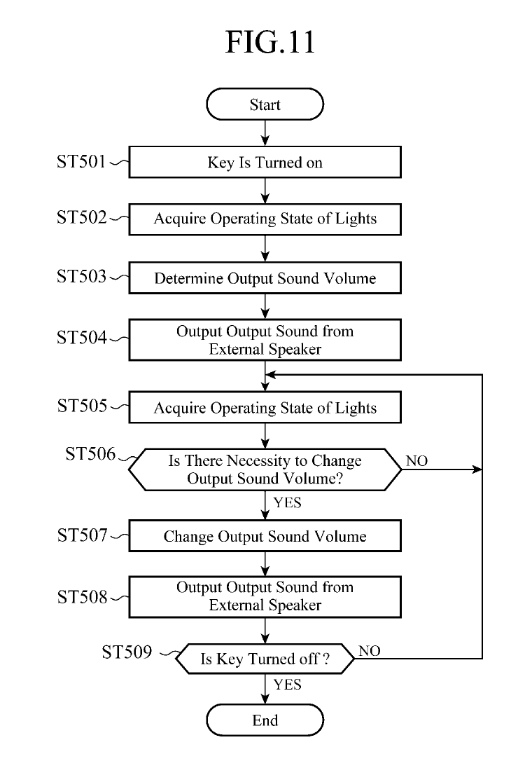

FIG. 10 is a block diagram showing the structure of a sound output device for electric vehicle 10E in accordance with Embodiment 5 of the present invention, and FIG. 11 is a flow chart showing a fundamental operation of the sound output device for electric vehicle 10E in accordance with Embodiment 5 of the present invention.

Referring to FIG. 10, the sound output device for electric vehicle differs from that in accordance with Embodiment 4 shown in FIG. 8 in that the sensor unit 124 which constructs the information acquiring unit 12 in Embodiment 4 is replaced by a light operating state notifying unit 125. The other structural components of the sound output device for electric vehicle are the same as those in accordance with Embodiment 4 shown in FIG. 8.

The light operating state notifying unit 125 detects an on or off state of headlights used for lighting during nighttime hours, for example, and notifies the one or off state to a condition determining unit 131 which constructs a control unit 13. In order to detect the on or off state of the headlights, the light operating state notifying unit uses an on/off signal for turning on or off the lights, for example. The light operating state notifying unit can alternatively use an illumination sensor. When the headlights stay unilluminated (off), the sound output device sets the sound volume of a sound which the sound output device outputs to outside the vehicle to a predetermined constant sound volume, whereas when the headlights stay illuminated (on), the sound output device sets the sound volume of the sound which the sound output device outputs to outside the vehicle to a predetermined constant sound volume which is smaller than that at the time that the headlights stay unilluminated.

A sound volume determining unit 132 determines the sound volume of the sound which the sound output device outputs to outside the vehicle from the lighting state of the headlights notified thereto from the condition determining unit 131, and informs the sound volume to a speaker output unit 133. Because there is a high possibility that when the headlights stay illuminated, the vehicle is travelling during nighttime hours, the control unit controls the output sound volume of the pseudo engine sound in such a way that the output sound volume is small than that at the time that the headlights stay unilluminated.

The speaker output unit 133 amplifies an output signal furnished thereto from a output sound producing unit 113 of a sound producing unit 11 in order to output the output signal at the sound volume determined by the sound volume determining unit 132 from speaker units (S−1, S−2, . . . , S−(N−1), and S−N) which are externally connected thereto, and drives the speaker units (S−1, S−2, . . . , S−(N−1), and S−N).

Explaining the operation with reference to FIG. 11, when the driver performs an operation of turning on an ignition key to cause the vehicle to supply ACC electric power to the sound output device first (step ST501), the condition determining unit 131 of the control unit 13 captures the information showing the lighting state of the headlights from the light operating state notifying unit 125 (step ST502), and determines whether or not the headlights stay on or off (whether or not the vehicle is travelling during nighttime hours).

The information determined by the condition determining unit 131 is sent to the sound volume determining unit 132, and the sound volume determining unit 132 determines the sound volume according to the information and then informs the sound volume to the speaker output unit 133 (step ST503). The speaker output unit 133 amplifies the output signal outputted from the output sound producing unit 113 of the sound producing unit 11 to output the output signal at the sound volume determined by the sound volume determining unit 132, and drives each of the speaker units (S−1, S−2, . . . , S−(N−1), and S−N) to output the pseudo engine sound having the predetermined sound volume (step ST504).

After the pseudo engine sound having the predetermined sound volume is outputted from the speaker units (S−1, S−2, . . . , S−(N−1), and S−N), the light operating state notifying unit 125 of the information acquiring unit 12 continues detecting the lighting state of the headlights, and then notifies the lighting state to the condition determining unit 131 of the control unit 13 every time when the light operating state notifying unit detects the lighting state (step ST505). The condition determining unit 131 determines whether or not there is a necessity to change the information showing whether the headlights are the on or off state from the detected lighting state of the headlights, and notifies whether or not there is a necessity to change the information to the sound volume determining unit 132 (step ST506).

The sound volume determining unit 132 determines the sound volume of the output sound according to the lighting state of the lights, and, when determining that there is a necessity to change the sound volume (when “YES” in step ST506), the sound volume determining unit notifies a change of the sound volume to the speaker output unit 133 (step ST507). When receiving a notification of a change of the sound volume, the speaker output unit 133 changes the amplification factor thereof in such a way that the output signal furnished thereto from the output sound producing unit 113 of the sound producing unit 11 has the desired sound volume, and drives each of the speaker units (S−1, S−2, . . . , S−(N−1), and S−N) (step ST508).

When the driver then, in step ST509, performs an operation of turning off the ignition key to disconnect the sound output device from the ACC electric power supply (when “YES” in step ST509), the sound output device stops the output of the pseudo sound from each of the speaker units (S−1, S−2, . . . , S−(N−1), and S−N).

In Embodiment 5, the condition determining unit determines whether or not the vehicle is travelling during nighttime hours by determining whether or not the headlights stay on or off. As an alternative, in a case in which a navigation unit is mounted in the vehicle, the sound output device can determine whether or not the vehicle is travelling during nighttime hours from current time information acquired from a GPS receiver or an internal clock. Also in Embodiment 5, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10E in accordance with Embodiment 5, the control unit 13 controls the sound volume according to the state information showing whether or not the lights stay illuminated, which is acquired by the information acquiring unit 12 (light operating state notifying unit 125). Therefore, because when the vehicle is traveling during nighttime hours, for example, pedestrians and passengers each riding on a light vehicle or a motorbike can easily notice the approach of the vehicle from the vehicle's headlights, the sound output device for electric vehicle can control the pseudo engine sound in such a way that the pseudo engine sound has a sound volume that is not larger than necessary according to the lighting state of the headlights. As a result, the sound output device for electric vehicle can prevent passengers riding on the vehicle and neighboring residents from hearing an unnecessary sound and then feeling displeasure at this sound.

### Embodiment 6

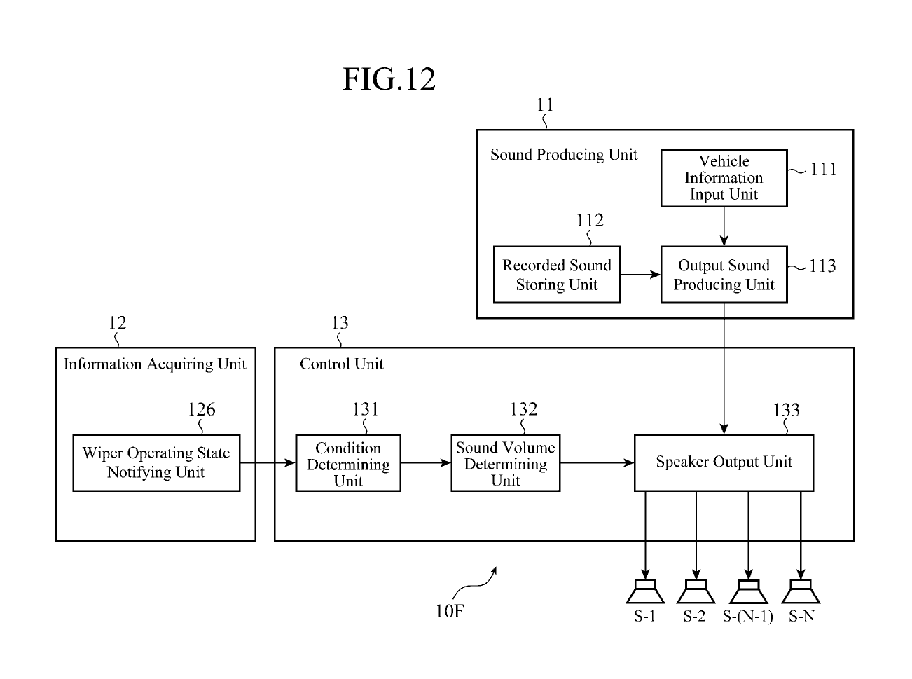

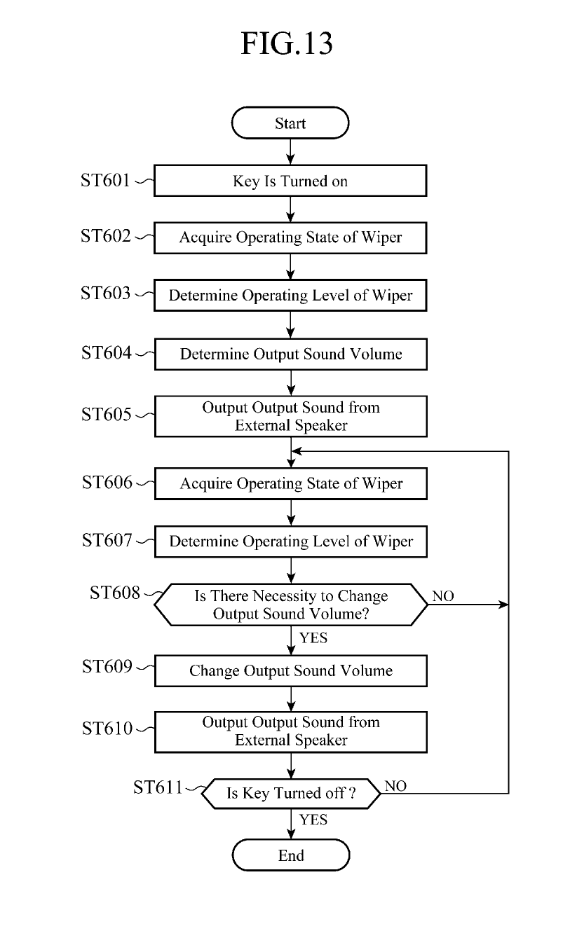

FIG. 12 is a block diagram showing the structure of a sound output device for electric vehicle 10F in accordance with Embodiment 6 of the present invention, and FIG. 13 is a flow chart showing a fundamental operation of the sound output device for electric vehicle 10F in accordance with Embodiment 6 of the present invention.

Referring to FIG. 12, the sound output device for electric vehicle differs from that in accordance with Embodiment 5 shown in FIG. 10 in that the light operating state notifying unit 125 which constructs the information acquiring unit 12 in Embodiment 5 is replaced by a wiper operating state notifying unit 126. The other structural components of the sound output device for electric vehicle are the same as those in accordance with Embodiment 5 shown in FIG. 10.

The wiper operating state notifying unit 126 detects the operating state of a wiper of the vehicle, and notifies this operating state to a condition determining unit 131 which constructs a control unit 13. The condition determining unit 131 determines an operating level of the wiper from the operating state of the wiper, and notifies the operating level to a sound volume determining unit 132. The operating level of the wiper notified to the sound volume determining unit is information showing the operating speed of the wiper, for example. When the operating speed of the wiper is the highest, the condition determining unit classifies the operating level as level 3, whereas when the wiper is not used, the condition determining unit classifies the operating level as level 1. When the operating speed of the wiper falls within the range between the highest one and zero, the condition determining unit classifies the operating level as level 1 or level 2 according to the operating speed. Because there is a possibility that the wiper is used even when the driver of the vehicle desires to remove dust from the front windshield or causes the vehicle to spray washer fluid onto the front windshield, other than when the vehicle is travelling in rainy weather, the condition determining unit needs to determine that the wiper is used only when the wiper is used for a certain fixed time or longer to determine the operating level of the wiper.

The sound volume determining unit 132 determines the sound volume of a sound which the sound output device outputs to outside the vehicle from the operating level of the wiper notified thereto from the condition determining unit 131, and informs the sound volume to a speaker output unit 133. When the operating level is classified as level 0 showing that the wiper is not used, the sound volume determining unit sets the sound volume to a normal one, while because it is judged that the vehicle is travelling in an environment where it is raining more heavily as the condition determining unit raises the operating level of the wiper, the sound volume determining unit needs to increase the sound volume of the pseudo engine sound which the sound output device outputs to outside the vehicle to larger than the normal one.

The speaker output unit 133 amplifies an output signal furnished thereto from an output sound producing unit 113 of a sound producing unit 11 in order to output the output signal at the sound volume determined by the sound volume determining unit 132 from speaker units (S−1, S−2, . . . , S−(N−1), and S−N) which are externally connected thereto, and drives the speaker units (S−1, S−2, . . . , S−(N−1), and S−N).

Explaining the operation with reference to FIG. 13, when the driver performs an operation of turning on an ignition key to cause the vehicle to supply ACC electric power to the sound output device first (step ST601), the condition determining unit 131 of the control unit 13 captures the operating state of the wiper from the wiper operating state notifying unit 126 (step ST602), and determines the operating level of the wiper (step ST603).

Information showing the operating level determined by the condition determining unit 131 is sent to the sound volume determining unit 132, and the sound volume determining unit 132 determines the sound volume of the sound which the sound output device outputs from the operating level and then notifies the sound volume to the speaker output unit 133 (step ST604). When receiving a notification of the determined sound volume, the speaker output unit 133 changes the amplification factor thereof in such a way that the output signal furnished thereto from the output sound producing unit 113 of the sound producing unit 11 has the desired sound volume, and drives each of the speaker units (S−1, S−2, . . . , S−(N−1), and S−N) (step ST605).

After the pseudo engine sound having the predetermined sound volume is outputted from the speaker units (S−1, S−2, . . . , S−(N−1), and S−N), the wiper operating state notifying unit 126 of the information acquiring unit 12 continues detecting the operating state of the wiper, and then notifies the operating state to the condition determining unit 131 of the control unit 13 every time when the wiper operating state notifying unit detects the operating state (step ST606). When receiving this notification, the condition determining unit 131 determines the operating level of the wiper (step ST607). When the operating state of the wiper varies, more specifically, when there is a necessity to change the output sound volume (when “YES” in step ST608), the condition determining unit 131 notifies the determined operating level of the wiper to the sound volume determining unit 132, and the sound volume determining unit 132 which has received this notification determines the sound volume according to the operating level and then notifies a change of the sound volume to the speaker output unit 133 (step ST609).

When receiving a notification of a change of the sound volume, the speaker output unit 133 changes the amplification factor thereof in such a way that the output signal furnished thereto from the output sound producing unit 113 of the sound producing unit 11 has the desired sound volume, and drives each of the speaker units (S−1, S−2, . . . , S−(N−1), and S−N) (step ST610). When the driver then, in step ST611, performs an operation of turning off the ignition key to disconnect the sound output device from the ACC electric power supply (when “YES” in step ST611), the sound output device stops the output of the pseudo sound from each of the speaker units (S−1, S−2, . . . , S−(N−1), and S−N).

Also in Embodiment 6, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10F in accordance with Embodiment 6, the control unit 13 controls the sound volume according to the operating state of the wiper which is vehicle state information acquired by the information acquiring unit 12 (wiper operating state notifying unit 125), thereby making it possible for pedestrians and so on to notice the approach of the vehicle. Concretely, the sound output device for electric vehicle can change the sound volume according to information showing how heavily it is raining which can be seen from the operating state of the wiper. Therefore, the sound output device for electric vehicle increases the sound volume in the case of a heavy rain which makes it difficult to notice the approach of the vehicle, thereby being able to provide an environment in which it is easy to notice the approach of the vehicle for pedestrians and so on.

### Embodiment 7

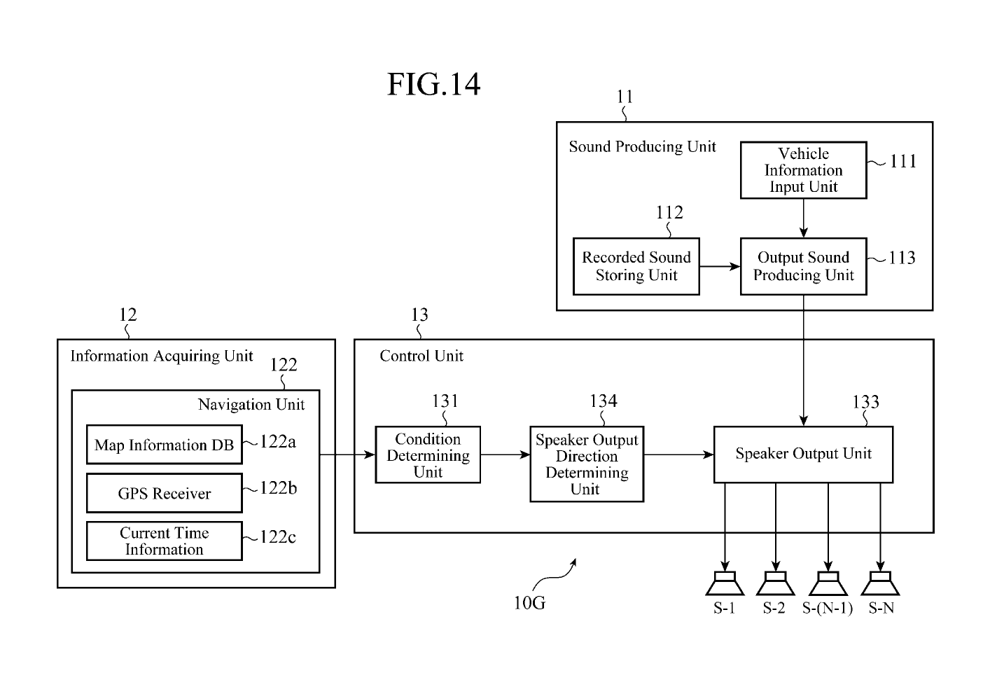

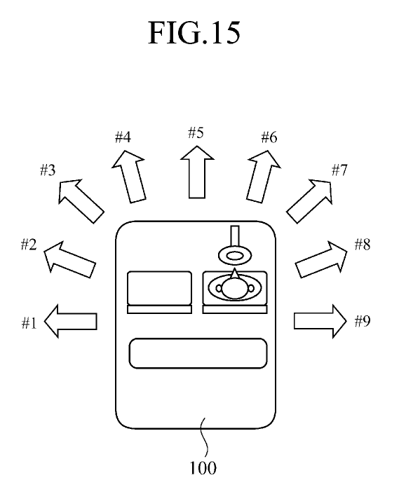

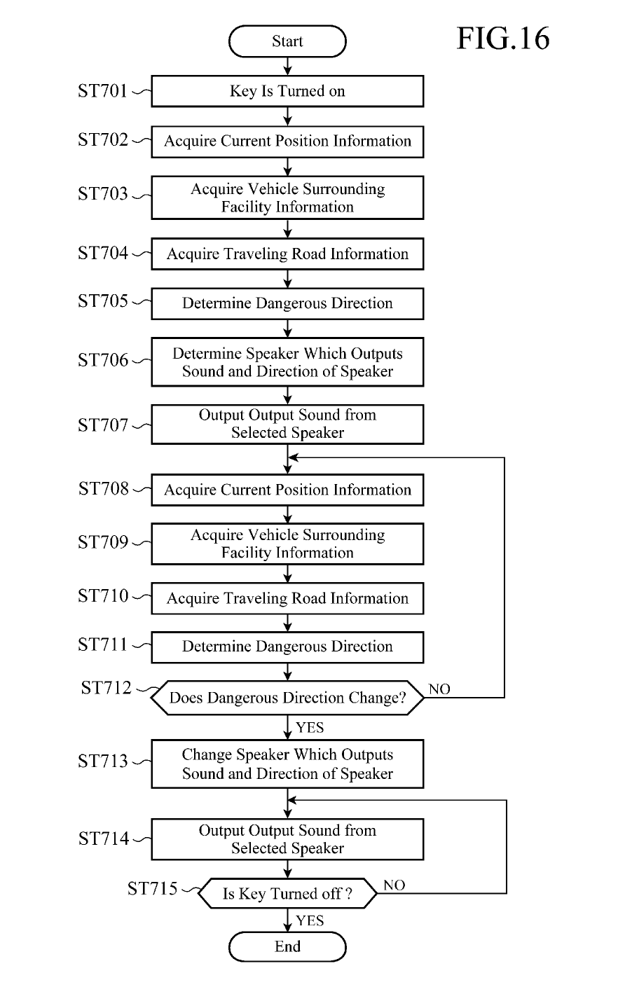

FIG. 14 is a block diagram showing the structure of a sound output device for electric vehicle 10G in accordance with Embodiment 7 of the present invention, FIG. 15 is a view showing an example of a direction in which the sound output device for electric vehicle in accordance with Embodiment 7 of the present invention outputs a sound, and FIG. 16 is a flow chart showing a fundamental operation of the sound output device for electric vehicle 10G in accordance with Embodiment 7 of the present invention.

Referring to FIG. 14, the sound output device for electric vehicle differs from that in accordance with Embodiment 2 shown in FIG. 4 in that the sound volume determining unit 132 which constructs the control unit 13 in Embodiment 2 is replaced by a speaker output direction determining unit 134. The other structural components of the sound output device for electric vehicle are the same as those in accordance with Embodiment 2 shown in FIG. 4.

The speaker output direction determining unit 134 has a function of operating in cooperation with a condition determining unit 131 and a speaker output unit 133 to control the direction in which the sound output device outputs a sound produced by a sound producing unit 11 according to information showing the current position of a vehicle and map information which are acquired from a navigation unit 122 which constructs an information acquiring unit 12.

In the control unit 13, the condition determining unit 131 determines a dangerous direction in the road along which the vehicle is traveling or an area surrounding the vehicle according to the surroundings which can be seen from the information showing the current position of the vehicle and the map information (the traveling road, surrounding facilities, etc.) which are captured from the navigation unit 122. Information showing the dangerous direction determined by the condition determining unit is outputted to the speaker output direction determining unit 134.

For example, the dangerous direction notified from the condition determining unit 131 to the speaker output direction determining unit is a direction in which a pedestrian crossing, an intersection, a point of frequent traffic accidents, a blind curve, or the like exists, a direction in which many pedestrians walk, a direction in which there is a high possibility that persons run into the road, a direction in which numerous accidents have occurred, a direction under low visibility conditions, the traveling direction, or the like. The dangerous direction shows which direction is dangerous by using information about facilities existing in an area surrounding the vehicle traveling, the traveling road, or the like.

As examples of this dangerous direction, directions #1 to #9 centered at the vehicle 100 can be provided, as shown in FIG. 15. The number of dangerous directions notified to the speaker output direction determining unit is not limited to one.

In order to output a pseudo engine sound in each dangerous direction notified thereto from the condition determining unit 131, the speaker output direction determining unit 134 determines which one of speakers mounted in the vehicle to use and with which angle to output the pseudo engine sound, and outputs the results of the determination to the speaker output unit 133.

The speaker output unit 133 changes the amplification factor thereof in such a way that a signal outputted from an output sound producing unit 113 of a sound producing unit 11 has a desired sound volume (i.e. a sound volume which is predetermined according to a danger level as explained in Embodiment 2), and selectively drives the corresponding one of the speaker units (S−1, S−2, . . . , S−(N−1), and S−N). More specifically, the speaker output unit selects the speaker unit which the speaker output unit should drive from among the speaker units (S−1, S−2, . . . , S−(N−1), and S−N) mounted to the vehicle so as to output the pseudo engine sound in each desired direction. As an alternative, the speaker output unit implements the output of the pseudo engine sound by changing the direction of the selected speaker. Furthermore, the speaker units can be constructed in such a way as to have super directivity so that the sound can be heard only in each desired direction.

Explaining the operation with reference to FIG. 16, when the driver performs an operation of turning on an ignition key to cause the vehicle to supply ACC electric power to the sound output device first (step ST701), the condition determining unit 131 of the control unit 13 captures current position information, vehicle surrounding facility information, traveling road information, etc. from the navigation unit 122 (steps ST702 to ST704), and then determines a dangerous direction (step ST705).

The dangerous direction determined by the condition determining unit 131 is notified to the speaker output direction determining unit 134, and the speaker output direction determining unit 134 selects a speaker unit via which the sound output device will output the pseudo engine sound in the dangerous direction notified thereto and determines the direction of the selected speaker unit, and outputs information showing the selection and determination to the speaker output unit 133 (step ST706). The speaker output unit 133 changes the amplification factor thereof and drives the selected one of the speaker units (S−1, S−2, . . . , S−(N−1), and S−N) in such a way that the output signal furnished thereto from the output sound producing unit 113 of the sound producing unit 11 has the desired sound volume (step ST707).

After the pseudo engine sound having the predetermined sound volume is outputted from the selected one of the speaker units (S−1, S−2, . . . , S−(N−1), and S−N), the navigation unit 122 of the information acquiring unit 12 acquires the information showing the current position of the vehicle, the vehicle surrounding facility information, the traveling road information, etc., and sends these pieces of information to the condition determining unit 131 of the control unit 13 (steps ST708 to ST710). When receiving the pieces of information, the condition determining unit 131 determines a dangerous direction (step ST711).

Information showing the dangerous direction determined by the condition determining unit 131 is sent to the speaker output direction determining unit 134, and the speaker output direction determining unit 134 selects a speaker unit via which the sound output device will output the pseudo engine sound in the dangerous direction notified thereto and determines the direction of the selected speaker unit. Next, the speaker output direction determining unit 134 compares the results of the selection and determination with the speaker unit currently outputting the pseudo engine sound and the direction of the speaker unit (step ST712), and, when there is a necessity to switch to the speaker unit selected as above (when “YES” in step ST712), notifies a switch to the selected speaker unit via which the sound output device will output the sound and a change of the direction to the speaker output unit 133 (step S713).

When receiving a notification of a switch to the selected speaker unit which outputs the sound and a change of the direction, the speaker output unit 133 changes the amplification factor thereof in such a way that the output signal furnished thereto from the output sound producing unit 113 of the sound producing unit 11 has the desired sound volume, and drives the selected one of the speaker units (one of S−1, S−2, . . . , S−(N−1), and S−N) toward the specified direction (step ST714).

When the driver then, in step ST715, performs an operation of turning off the ignition key to disconnect the sound output device from the ACC electric power supply (when “YES” in step ST715), the sound output device stops the output of the pseudo sound from the selectively-driven one of the speaker units (one of S−1, S−2, . . . , S−(N−1), and S−N).

Also in Embodiment 7, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10G in accordance with Embodiment 7, the control unit 13 makes it possible for pedestrians and so on to notice the approach of the vehicle effectively by controlling the output direction of the sound produced by the sound producing unit 11 according to the current position information which is state information of the vehicle and the map information which is surroundings information, the current position information and the map information being acquired from the information acquiring unit 12. For example, by actively outputting the sound in the traveling direction, a direction in which a pedestrian crossing, an intersection, a point of frequent traffic accidents, a blind curve, or the like exists, a direction in which many pedestrians walk, a direction in which there is a high possibility that persons run into the road, a direction in which numerous accidents have occurred, a direction under low visibility conditions, or the like, the sound output device makes it easy for pedestrians and so on to notice the approach of the vehicle. Furthermore, because the sound output device does not have to output the sound in any directions other than the determined direction at a frequency more than necessary, the degree of displeasure inflicted on neighboring residents by the sound can be reduced.

### Embodiment 8

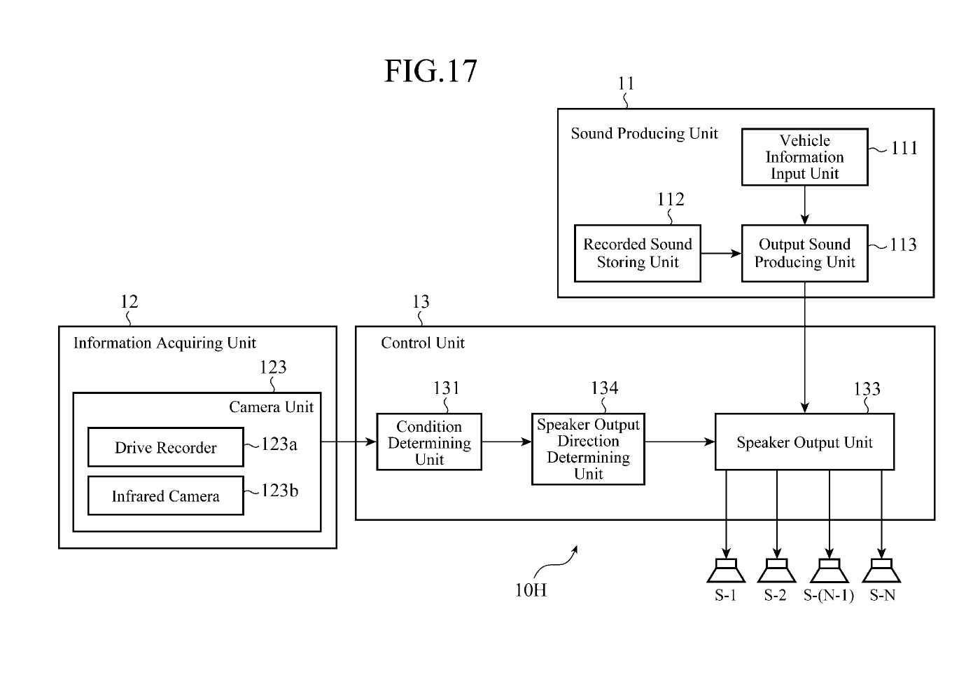

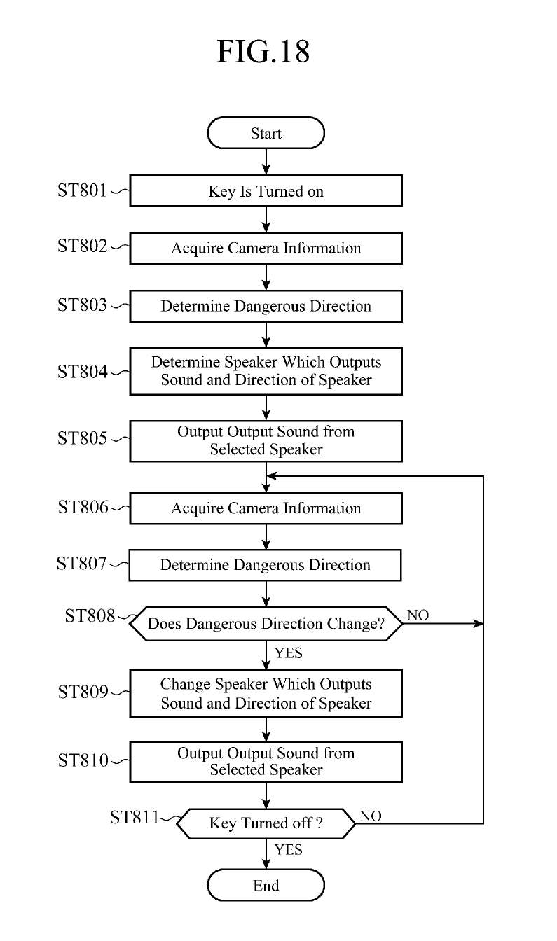

FIG. 17 is a block diagram showing the structure of a sound output device for electric vehicle 10H in accordance with Embodiment 8 of the present invention, and FIG. 18 is a flow chart showing a fundamental operation of the sound output device for electric vehicle 10H in accordance with Embodiment 8 of the present invention.

Referring to FIG. 17, the sound output device for electric vehicle differs from that in accordance with Embodiment 3 shown in FIG. 6 in that the sound volume determining unit 132 which constructs the control unit 13 in Embodiment 2 is replaced by a speaker output direction determining unit 134. The other structural components of the sound output device for electric vehicle are the same as those in accordance with Embodiment 3 shown in FIG. 6.

The speaker output direction determining unit 134 has a function of operating in cooperation with a condition determining unit 131 and a speaker output unit 133 to control the direction of a sound which a sound producing unit 11 produces according to a shot image of an area surrounding a vehicle which is acquired by a camera unit 123 which constructs an information acquiring unit 12.

In the control unit 13, the condition determining unit 131 performs an image analysis on the image of the area extending in the traveling direction of the vehicle which is captured by the camera unit 123 which constructs the information acquiring unit 12, and, when finding out an object such as a pedestrian, a light vehicle, or a motorbike in the traveling direction or when the vehicle approaches at a predetermined distance or less from such an object, determines the direction of the object as a dangerous direction and then notifies this dangerous direction to the speaker output direction determining unit 134.

In this embodiment, as this dangerous direction, directions #1 to #9 centered at the vehicle 100 can be provided as shown in FIG. 15, like in the case of above-mentioned Embodiment 7. When not finding out any object such as a pedestrian, a light vehicle or a motorbike, in an area in front of the vehicle, the sound output device determines the dangerous direction as zero and sets a normal output direction as the direction in which the sound output device outputs a sound.

In order to output a pseudo engine sound in the dangerous direction notified thereto from the condition determining unit 131, the speaker output direction determining unit 134 determines which one of speakers mounted in the vehicle to use and with which angle to output the pseudo engine sound, and outputs the results of the determination to a speaker output unit 133.

The speaker output unit 133 changes the amplification factor thereof in such a way that a signal outputted from an output sound producing unit 113 of a sound producing unit 11 has a desired sound volume (i.e. a sound volume which is predetermined according to a danger level as explained in Embodiment 3) is outputted at a desired angle, and selectively drives the corresponding one of the speaker units (S−1, S−2, . . . , S−(N−1), and S−N). More specifically, the speaker output unit selects the speaker unit which the speaker output unit should drive from among the speaker units (S−1, S−2, . . . , S−(N−1), and S−N) mounted to the vehicle so as to output the pseudo engine sound in the desired direction. As an alternative, the speaker output unit implements the output of the pseudo engine sound by changing the direction of the selected speaker. Furthermore, the speaker units can be constructed in such a way as to have super directivity so that the sound can be heard only in the desired direction.

Explaining the operation with reference to FIG. 18, when the driver performs an operation of turning on an ignition key to cause the vehicle to supply ACC electric power to the sound output device first (step ST801), the condition determining unit 131 of the control unit 13 performs an image analysis on the image of the area extending in the traveling direction of the vehicle which is captured by the camera unit 123, and then determines whether an object such as a pedestrian, a light vehicle, or a motorbike exists in an area extending in the traveling direction. At this time, when determining that an object such as a pedestrian, a light vehicle, or a motorbike exists in an area extending in the traveling direction or when determining that the vehicle approaches at a predetermined distance or less from such an object, the condition determining unit determines the direction of the object as a dangerous direction (step ST803).

The dangerous direction determined by the condition determining unit 131 is notified to the speaker output direction determining unit 134, and the speaker output direction determining unit 134 selects one of the speaker unit (S−1, S−2, . . . , S−(N−1), and S−N) via which the sound output device will output the sound in the dangerous direction notified thereto and determines the direction of the selected one of the speaker units (one of S−1, S−2, . . . , S−(N−1), and S−N), and outputs the results of the selection and determination to the speaker output unit 133 (step ST804).

The speaker output unit 133 changes the amplification factor thereof and drives the selected one of the speaker units (S−1, S−2, . . . , S−(N−1), and S−N) in such a way that the output signal outputted from the output sound producing unit 113 of the sound producing unit 11 propagates toward the desired direction and has the desired sound volume (step ST805).

After the pseudo engine sound having the predetermined sound volume is outputted in the predetermined direction from the selected one of the speaker units (S−1, S−2, . . . , S−(N−1), and S−N), the camera unit 123 of the information acquiring unit 12 captures a shot image of an area extending in the traveling direction and outputs the shot image to the condition determining unit 131 of the control unit 13 (step ST806), and the condition determining unit 131 which has received this image determines a dangerous direction (step ST807).

Information showing the dangerous direction determined by the condition determining unit 131 is sent to the speaker output direction determining unit 134, and the speaker output direction determining unit 134 selects one of the speaker units (S−1, S−2, . . . , S−(N−1), and S−N) via which the sound output device will output the pseudo engine sound in the dangerous direction notified thereto and determines the direction of the selected one of the speaker units (one of S−1, S−2, . . . , S−(N−1), and S−N). The speaker output direction determining unit 134 further compares the results of the selection and determination with the speaker unit currently outputting the pseudo engine sound and the direction of the speaker unit (step ST808), and, when there is a necessity to switch to the speaker unit selected as above (when “YES” in step ST808), notifies a switch to the selected one of the speaker units (one of S−1, S−2, . . . , S−(N−1), and S−N) via which the sound output device will output the sound and a change of the direction to the speaker output unit 133 (step S809).

When receiving a notification of a switch to the selected speaker unit via which the sound output device will output the sound and a change of the direction, the speaker output unit 133 changes the amplification factor thereof and drives the selected one of the speaker units (one of S−1, S−2, . . . , S−(N−1), and S−N) toward the specified direction in such a way that the output signal outputted from the output sound producing unit 113 of the sound producing unit 11 has the desired sound volume (step ST810).

When the driver then, in step ST811, performs an operation of turning off the ignition key to disconnect the sound output device from the ACC electric power supply (when “YES” in step ST811), the sound output device stops the output of the pseudo sound from the selectively-driven one of the speaker units (one of S−1, S−2, . . . , S−(N−1), and S−N). Also in Embodiment 8, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10H in accordance with Embodiment 8, the control unit 13 makes it possible for pedestrians and so on to notice the approach of the vehicle effectively by controlling the direction in which the sound output device outputs the sound according to a shot image of an area surrounding the vehicle which is surroundings information about the vehicle acquired by the information acquiring unit 12. For example, by capturing a shot image of an area extending in the traveling direction from a drive recorder 123a, an infrared camera 123b, or the like, and then performing an image analysis on the image, the sound output device can change the direction in which the pseudo engine sound, which the sound output device outputs to outside the vehicle, propagates according to whether an object such as a pedestrian, a light vehicle or a motorbike exists in an area extending in the traveling direction. Therefore, when recognizing a pedestrian or a passenger on a light vehicle or a motorbike existing in a direction, the sound output device outputs the pseudo engine sound in the direction, thereby being able to enhance the ability to get notice of the approach of the vehicle. Furthermore, because the sound output device does not have to output the sound in any directions other than the direction at a frequency more than necessary, the sound output device does not cause any inconvenience to neighboring residents.

### Embodiment 9

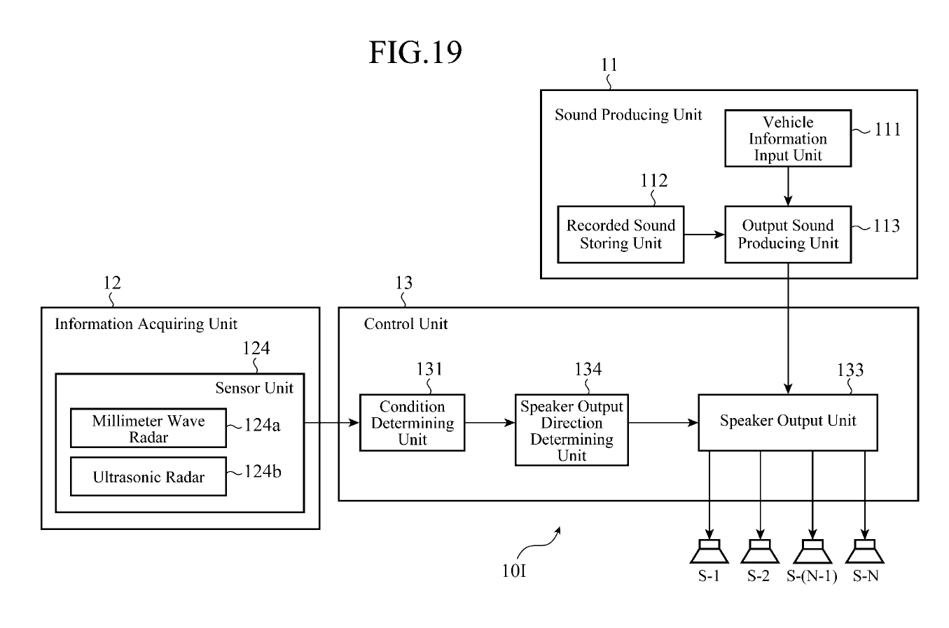

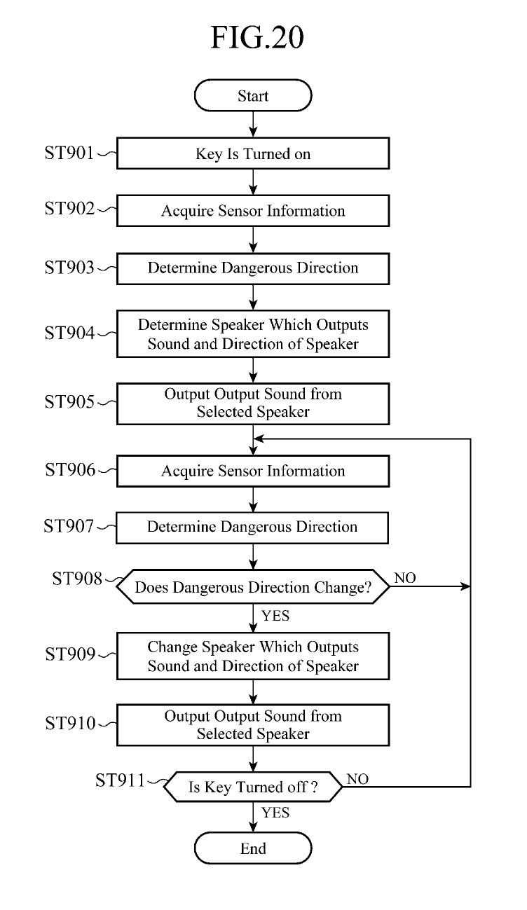

FIG. 19 is a block diagram showing the structure of a sound output device for electric vehicle 10I in accordance with Embodiment 9 of the present invention, and FIG. 20 is a flow chart showing a fundamental operation of the sound output device for electric vehicle 10I in accordance with Embodiment 9 of the present invention.

Referring to FIG. 19, the sound output device for electric vehicle differs from that in accordance with Embodiment 4 shown in FIG. 8 in that the sound volume determining unit 132 which constructs the control unit 13 in Embodiment 4 is replaced by a speaker output direction determining unit 134. The other structural components of the sound output device for electric vehicle are the same as those in accordance with Embodiment 4 shown in FIG. 8.

The speaker output direction determining unit 134 has a function of operating in cooperation with a condition determining unit 131 and a speaker output unit 133 to control the direction in which the sound output device outputs a sound produced by a sound producing unit 11 according to distance information about the distance to a target for notification which is acquired from a sensor unit 124 which constructs an information acquiring unit 12.

One or more millimeter wave radars 124a and one or more ultrasonic radars 124b are mounted, as the sensor unit 124, in each of front and side portions of a vehicle, as explained in Embodiment 4. This sensor unit 124 notifies the results of a determination of whether or not an object such as a pedestrian, a light vehicle or a motorbike exists in an area surrounding the vehicle, and detection of the direction in which such a target for notification exists to the condition determining unit 131 of the control unit 13.

When recognizing that an object such a pedestrian, alight vehicle or a motorbike exists from the detection results acquired by the sensor unit 124, the condition determining unit 131 determines the direction of such an object as a dangerous direction, and notifies this dangerous direction to the speaker output direction determining unit 134. In this embodiment, as examples of this dangerous direction, directions #1 to #9 centered at the vehicle 100 can be provided, as shown in FIG. 15, like in the case of above-mentioned Embodiment 7. When not finding out any object such as a pedestrian, a light vehicle or a motorbike in an area in front of the vehicle, the sound output device determines the dangerous direction as zero and sets a normal output direction as the direction in which the sound output device outputs a sound.

In order to output a pseudo engine sound in the dangerous direction notified thereto from the condition determining unit 131, the speaker output direction determining unit 134 determines which one of speakers (S−1, S−2, . . . , S−(N−1), and S−N) mounted in the vehicle to use and with which angle to output the pseudo engine sound, and outputs the results of the determination to a speaker output unit 133.

The speaker output unit 133 changes the amplification factor thereof in such a way that a signal outputted from an output sound producing unit 113 of a sound producing unit 11 has a desired sound volume (i.e. a sound volume which is predetermined according to a danger level as explained in Embodiment 4) and is outputted at a desired angle, and selectively drives the corresponding one of speaker units (S−1, S−2, . . . , S−(N−1), and S−N). More specifically, the speaker output unit selects the speaker unit which the speaker output unit should drive from among the speaker units (S−1, S−2, . . . , S−(N−1), and S−N) mounted to the vehicle so as to output the pseudo engine sound in the desired direction and with the desired sound volume. As an alternative, the speaker output unit implements the output of the pseudo engine sound by changing the direction of the selected speaker. Furthermore, the speaker units can be constructed in such a way as to have super directivity so that the sound can be heard only in the desired direction.

Explaining the operation with reference to FIG. 20, when the driver performs an operation of turning on an ignition key to cause the vehicle to supply ACC electric power to the sound output device first (step ST901), the condition determining unit 131 of the control unit 13 captures the results of a determination of whether or not an object such as a pedestrian, a light vehicle or a motorbike exists in an area surrounding the vehicle, and detection of the angle at which such a target for notification exists with respect to the traveling direction of the vehicle from the sensor unit 124 of the information acquiring unit 12 (step ST902). When then determining that an object such as a pedestrian, a light vehicle or a motorbike exists in the surrounding area, the condition determining unit 131 determines the direction of the object as a dangerous direction (step ST903).

The dangerous direction determined by the condition determining unit 131 is notified to the speaker output direction determining unit 134, and the speaker output direction determining unit 134 selects one of the speaker units (S−1, S−2, . . . , S−(N−1), and S−N) via which the sound output device will output the sound in the dangerous direction notified thereto and determines the direction of the selected one of the speaker units (one of S−1, S−2, . . . , S−(N−1), and S−N), and outputs the results of the selection and determination to the speaker output unit 133 (step ST904).

The speaker output unit 133 changes the amplification factor thereof and drives the selected one of the speaker units (S−1, S−2, . . . , S−(N−1), and S−N) in such a way that the output signal outputted from the output sound producing unit 113 of the sound producing unit 11 propagates toward the desired direction and has the desired sound volume (step ST905).

After the pseudo engine sound having the predetermined sound volume is outputted in the predetermined direction from the selected one of the speaker units (S−1, S−2, . . . , S−(N−1), and S−N), the sensor unit 124 of the information acquiring unit 12 detects a target for notification of the pseudo engine sound, such as a pedestrian, a light vehicle or a motorbike, and captures information about the target, and then outputs this information to the condition determining unit 131 of the control unit 13 (step ST906). The condition determining unit 131 which has received this information determines a dangerous direction (step ST907).

Information showing the dangerous direction determined by the condition determining unit 131 is sent to the speaker output direction determining unit 134, and the speaker output direction determining unit 134 selects one of the speaker units (S−1, S−2, . . . , S−(N−1), and S−N) via which the sound output device will output the pseudo engine sound in the dangerous direction notified thereto and determines the direction of the selected one of the speaker units (one of S−1, S−2, . . . , S−(N−1), and S−N). The speaker output direction determining unit 134 further compares the results of the selection and determination with the speaker unit currently outputting the pseudo engine sound and the direction of the speaker unit (step ST908), and, when there is a necessity to switch to the speaker unit selected as above (when “YES” in step ST808), notifies a switch to the selected one of the speaker units (one of S−1, S−2, . . . , S−(N−1), and S−N) via which the sound output device will output the sound and a change of the direction to the speaker output unit 133 (step ST909).

When receiving a notification of a switch to the selected speaker unit via which the sound output device will output the sound and a change of the direction, the speaker output unit 133 changes the amplification factor thereof and drives the selected one of the speaker units (one of S−1, S−2, . . . , S−(N−1), and S−N) toward the specified direction in such a way that the output signal outputted from the output sound producing unit 113 of the sound producing unit 11 has the desired sound volume (step ST910).

When the driver then, in step ST911, performs an operation of turning off the ignition key to disconnect the sound output device from the ACC electric power supply (when “YES” in step ST911), the sound output device stops the output of the pseudo sound from the selectively-driven one of the speaker units (one of S−1, S−2, . . . , S−(N−1), and S−N). Also in Embodiment 9, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10I in accordance with Embodiment 9, the control unit 13 makes it possible for pedestrians and so on to notice the approach of the vehicle effectively by controlling the direction in which the sound output device outputs the sound according to distance information about the distance to a target for notification which is acquired by the information acquiring unit 12.

For example, by performing detection of an object such as a pedestrian, a light vehicle or a motorbike in an area surrounding the vehicle from the millimeter wave radar 124a, the ultrasonic radar 124b, or the like, the sound output device can change the direction of the pseudo engine sound which the sound output device outputs to outside the vehicle according to whether a pedestrian exists in the traveling direction of the vehicle and whether a light vehicle or a motorbike exists in a direction. Therefore, when recognizing an object such as a pedestrian, a light vehicle or a motorbike existing in the traveling direction of the vehicle, the sound output device outputs the pseudo engine sound in the direction, thereby making it easy for pedestrians and passengers each riding on a light vehicle or a motorbike who are targets for notification to notice the approach of the vehicle. Furthermore, because the sound output device does not have to output the sound in any directions other than the direction at a frequency more than necessary, the sound output device does not impose any inconvenience, which is caused due to the informing sound, on neighboring residents.

### Embodiment 10

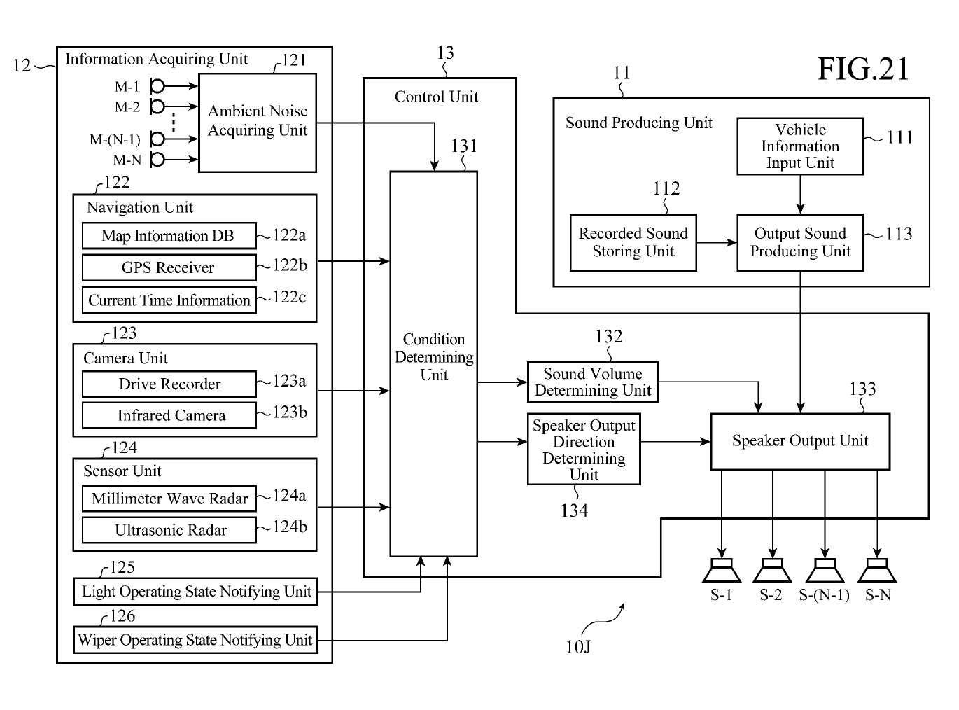

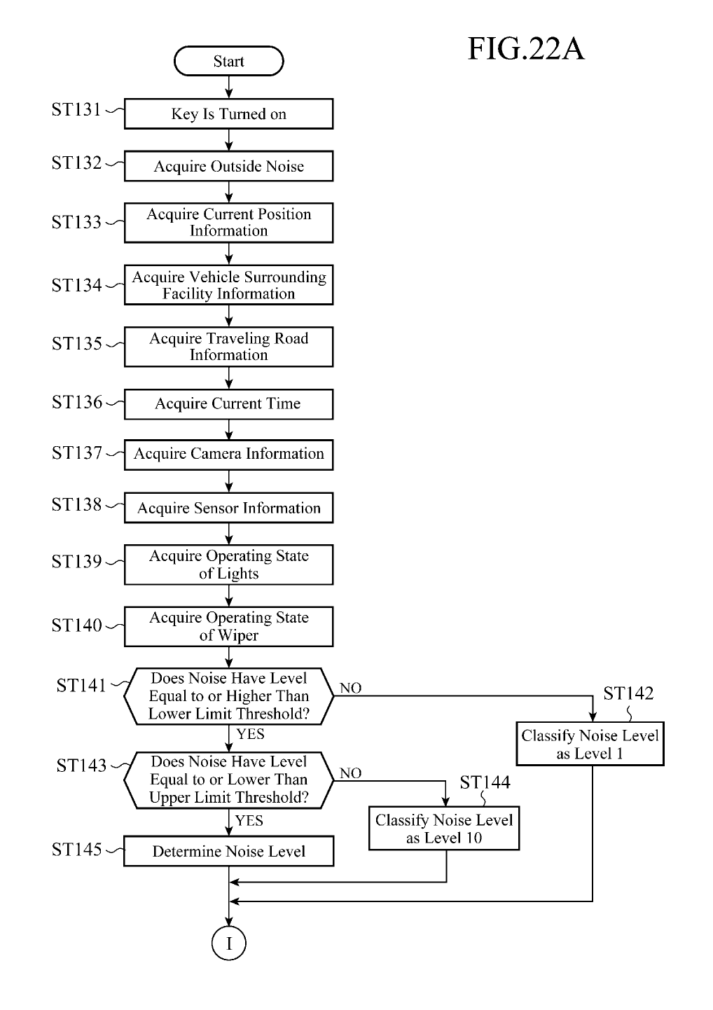

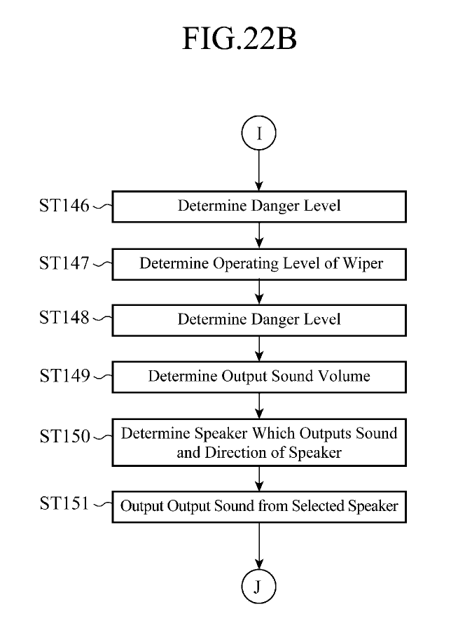

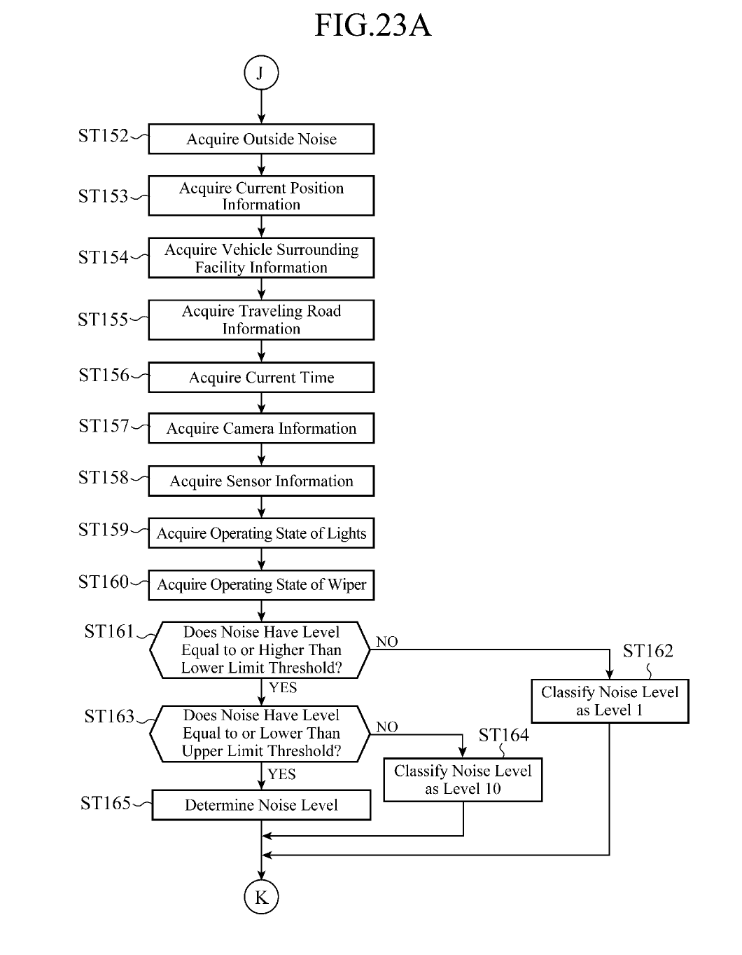

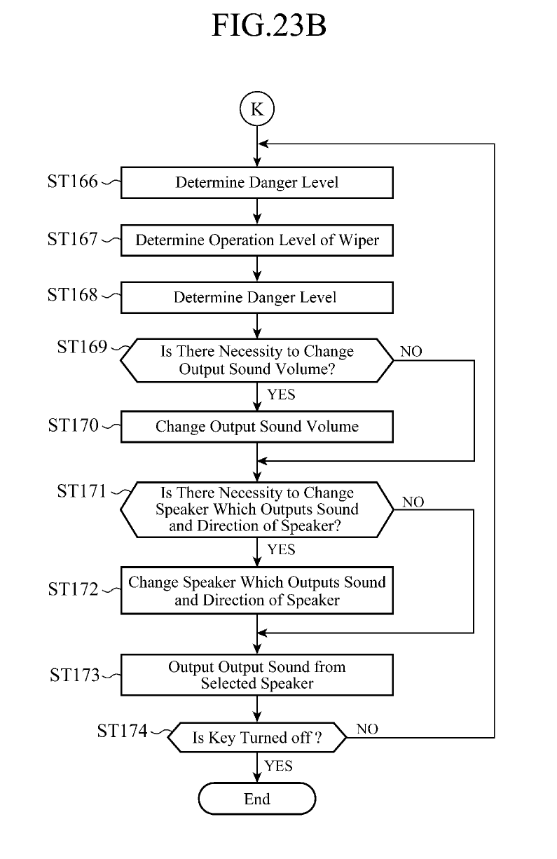

FIG. 21 is a block diagram showing the structure of a sound output device for electric vehicle 10J in accordance with Embodiment 10 of the present invention, and FIGS. 22A and 22B, and 23A and 23B are flow charts showing a fundamental operation of the sound output device for electric vehicle 10J in accordance with Embodiment 10 of the present invention.

The sound output device for electric vehicle 10J in accordance with Embodiment 10 which will be explained hereafter has a structure which is a combination of those according to above-mentioned Embodiments 1 to 9. More specifically, the sound output device for electric vehicle includes an ambient noise acquiring unit 121, a navigation unit 122, a camera unit 123, a sensor unit 124, a light operating state notifying unit 125, and a wiper operating state notifying unit 126 as an information acquiring unit 12. Because the functions of these components of the information acquiring unit 12 are explained in Embodiments 1 to 9, the detailed explanation of the functions will be omitted hereafter to avoid a duplicate explanation.

Because the information acquiring unit is constructed as above, a control unit 13 includes a sound volume determining unit 132 and a speaker output direction determining unit 134, and these units operate in cooperation with a condition determining unit 131 and a speaker output unit 133 to be able to output, for example, a pseudo engine sound which is outputted from a sound producing unit 11 with an optimal sound volume and in an optimal direction.

Concretely, the condition determining unit 131 determines a noise level, a danger level, the operating state of lights, an operating level of a wiper, and so on on the basis of information showing an outside noise which is captured from the ambient noise acquiring unit 121, current position information, map information and current time information, which are captured from the navigation unit 122, a shot image of an area extending in the traveling direction of a vehicle which is captured from the camera unit 123, the results of detection of a target for notification which are captured from the sensor unit 124, the operating state of the lights which is captured from the light operating state notifying unit 125, and the operating state of the wiper which is captured from the wiper operating state notifying unit 126, and sends the pieces of information to the sound volume determining unit 132. The condition determining unit 131 also notifies a dangerous direction determined thereby to the speaker output direction determining unit 134.

The sound volume determining unit 132 makes an overall determination on the basis of the various pieces of information which are notified from the condition determining unit 131 and which include the noise level, the danger level, the operating state of the lights, and the operating level of the wiper, and determines the sound volume of the pseudo engine sound which the sound output device outputs from speaker units (S−1, S−2, . . . , S−(N−1), and S−N), and informs the sound volume to the speaker output unit 133. As an example of the overall determination, there can be a determination of the output sound volume according to the largest one of the noise level, the danger level, a level showing the operating state of the lights, and the operating level of the wiper, which are determined by the condition determining unit 131, or a determination of the output sound volume according to the results of calculation of the products of those actually-determined levels and corresponding weighting factors predetermined for sound volume determination.

In order to output the sound in the dangerous direction notified thereto from the condition determining unit 131, the speaker output direction determining unit 134 also determines which one of the speakers (S−1, S−2, . . . , S−(N−1), and S−N) mounted in the vehicle to use and with which angle to output the sound, and outputs the results of the determination to the speaker output unit 133.

The speaker output unit 133 amplifies an output signal outputted from an output sound producing unit 113 of the sound producing unit 11 to output the output signal at the sound volume determined by the sound volume determining unit 132, and then outputs the pseudo engine sound in the determined direction from the one of the speaker units (S−1, S−2, . . . , S−(N−1), and S−N) which is determined by the speaker output direction determining unit 134.

In order to output the pseudo engine sound in the desired direction and with the desired sound volume, the one or more speakers for external output (S−1, S−2, . . . , S−(N−1), and S−N) are disposed in the vehicle, and the sound output device selects one of the speaker units (one of S−1, S−2, . . . , S−(N−1), and S−N) via which the sound output device outputs the pseudo engine sound, or changes the direction of one speaker unit selected thereby. As an alternative, the speaker units can be constructed in such a way as to have super directivity so that the sound can be heard only in the desired direction.

Explaining the operation with reference to FIGS. 22A and 22B, and 23A and 23B, when the driver performs an operation of turning on an ignition key to cause the vehicle to supply ACC electric power to the sound output device first (step ST131 shown in FIGS. 22A and 22B), the condition determining unit 131 of the control unit 13 captures the information showing an outside noise, the current position information (including vehicle surrounding facility information, traveling road information, and the current time information), a shot image of the area extending in the traveling direction, the results of detection of a target for notification, the operating state of the lights, the operating state of the wiper, etc. from the ambient noise acquiring unit 121, the navigation unit 122, the camera unit 123, the sensor unit 124, the light operating state notifying unit 125, and the wiper operating state notifying unit 126, and sends these pieces of information to the condition determining unit 131 of the control unit 13 (steps ST132 to ST140).

The condition determining unit 131 determines the noise level (steps ST141 to ST145), determines the danger level (step ST146), determines the operating level of the wiper (step ST147), and also determines a dangerous direction (step ST148) on the basis of the various pieces of information which are captured thereby. The noise level, the danger level, the operating level of the wiper, and the operating state of the lights, which are determined by the condition determining unit 131, are all notified to the sound volume determining unit 132, and the sound volume determining unit 132 determines the output sound volume from the various pieces of information notified thereto (step ST149) and informs the sound volume to the speaker output unit 133.

The dangerous direction is notified to the speaker output direction determining unit 134, and the speaker output direction determining unit 134 selects one of the speaker units (S−1, S−2, . . . , S−(N−1), and S−N) via which the sound output device outputs the pseudo engine sound in the dangerous direction notified thereto and determines the direction of the selected one of the speaker units (one of S−1, S−2, . . . , S−(N−1), and S−N) (step ST150), and outputs the results of the selection and determination to the speaker output unit 133.

The speaker output unit 133 amplifies the output signal outputted from the output sound producing unit 113 of the sound producing unit 11 to output the output signal at the sound volume determined by the sound volume determining unit 132, and then outputs the pseudo engine sound in the determined direction from the one of the speaker units (S−1, S−2, . . . , S−(N−1), and S−N) which is determined by the speaker output direction determining unit 134 (step ST151).

In order to output the pseudo engine sound in the desired direction and with the desired sound volume, the one or more speakers for external output (S−1, S−2, . . . , S−(N−1), and S−N) are disposed in the vehicle, and the sound output device selects one of the speaker units (one of S−1, S−2, . . . , S−(N−1), and S−N) via which the sound output device outputs the pseudo engine sound, or changes the direction of one speaker unit selected thereby. As an alternative, the speaker units can be constructed in such a way as to have super directivity so that the sound can be heard only in the desired direction.

After the pseudo engine sound having the predetermined sound volume is outputted in the predetermined direction from the selected one of the speaker units (S−1, S−2, . . . , S−(N−1), and S−N), the information acquiring unit 12 sends the information showing an outside noise from the ambient noise acquiring unit 121, the current position information, the vehicle surrounding facility information, the traveling road information, and the current time information from the navigation unit 122, an image of an area extending in the traveling direction from the camera unit 123, the detection results acquired by sensors from the sensor unit 124, the information showing the operating state of the lights from the light operating state notifying unit 125, the information showing the operating state of the wiper from the wiper operating state notifying unit 126 to the condition determining unit 131 of the control unit 13 (steps ST152 to ST160 shown in FIGS. 23A and 23B).

The condition determining unit 131 determines the noise level, the danger level, the operating state of the lights, the operating level of the wiper, and a dangerous direction according to the various pieces of information notified thereto (steps ST161 to ST168). The noise level, the danger level, the operating state of the lights, and the operating level of the wiper which are determined by the condition determining unit are notified to the sound volume determining unit 132, and the sound volume determining unit 132 determines a sound volume matching the various pieces of information notified thereto. At this time, the sound volume determining unit 132 compares the sound volume determined thereby with the sound volume of the output sound which the sound output device has outputted until now (step ST169). When there is a necessity to change the sound volume (when “YES” in step ST169), the sound volume determining unit notifies a change of the sound volume to the speaker output unit 133 (step ST170).

On the other hand, the dangerous direction determined by the condition determining unit 131 is notified to the speaker output direction determining unit 134, and the speaker output direction determining unit 134 selects one of the speaker units (S−1, S−2, . . . , S−(N−1), and S−N) via which the sound output device will output a sound from the dangerous direction and determines the direction of the selected one of the speaker units (one of S−1, S−2, . . . , S−(N−1), and S−N).

The speaker output direction determining unit 134 further compares the results of the selection and determination with the speaker unit (one of S−1, S−2, . . . , S−(N−1), and S−N) currently outputting the sound and the direction of the speaker unit (step ST171), and, when there is a necessity to switch to the speaker unit selected as above (when “YES” in step ST171), notifies a switch to the selected one of the speaker units (one of S−1, S−2, . . . , S−(N−1), and S−N) via which the sound output device will output a sound and a change of the direction to the speaker output unit 133 (step ST172).

When receiving a notification of a switch to the selected speaker unit (S−1, S−2, . . . , S−(N−1), or S−N), the direction of the speaker unit, and a change of the sound volume, the speaker output unit 133 amplifies the signal outputted from the output sound producing unit 113 of the sound producing unit 11 to output the output signal at the sound volume determined by the sound volume determining unit 132, and outputs a pseudo engine sound toward the determined direction via the one of the speaker units (S−1, S−2, . . . , S−(N−1), and S−N) which is determined by the speaker output direction determining unit 134 (step ST173).

When the driver then performs an operation of turning off the ignition key to disconnect the sound output device from the ACC electric power supply (when “YES” in step ST174), the sound output device stops the output of the pseudo sound from the selectively-driven one of the speaker units (one of S−1, S−2, . . . , S−(N−1), and S−N). Also in Embodiment 10, the sound output device for electric vehicle can change the tone of the informing sound produced thereby according to the vehicle information, such as the type and size of the vehicle, which the driver specifies by operating a vehicle information input unit 111 of the sound producing unit 11 at the time of initial settings, like that according to above-mentioned Embodiment 1.

In the sound output device for electric vehicle 10J in accordance with Embodiment 10, the control unit 13 makes it possible for pedestrians and so on to notice the approach of the vehicle more effectively by controlling the sound volume of the sound produced by the sound producing unit 11 and the direction in which the sound producing unit 11 outputs the sound by using a combination of two or more of the current position information, the map information, the shot image, the distance to a target for notification, and whether or not a target for notification is approaching the vehicle, which are pieces of surroundings information acquired by the information acquiring unit 12, and lamp operating state information and wiper operating state information, which are pieces of state information acquired by the information acquiring unit 12.

More specifically, the sound output device for electric vehicle can grasp the surroundings and the surrounding environment of the vehicle from the level of an outside noise occurring in the area surrounding the vehicle, the map information and the current position information, the pieces of information acquired by the camera unit and the sensor unit, and the operating state of the lights and the operating state of the wiper, and can select one of the speaker units (S−1, S−2, . . . , S−(N−1), and S−N) via which the sound output device will output the sound to outside the vehicle, determine the sound volume, and select the direction in which the sound output device will output the sound, and can change the speaker unit which outputs the sound, the sound volume and the direction. Therefore, when an object such as a pedestrian or a passenger riding on a light vehicle or a motorbike is approaching the vehicle or when the vehicle is travelling in an area in which running out or the accident, the sound output device increases the output sound and outputs the sound toward the direction of such an object, thereby being able to enhance the ability to get notice of the approach of the vehicle. Furthermore, when not finding out any object, such as a pedestrian or a passenger riding on a light vehicle or a motorbike, existing in the traveling direction of the vehicle, and when the vehicle is travelling in an area in which there is no necessity to increase the sound volume, the sound output device can also perform a control operation of not producing the sound at a frequency more than necessary. In this case, the sound output device can prevent passengers riding on the vehicle and neighboring residents from feeling bad.

All of the functions which the control unit 13 shown in FIG. 1, 4, 6, 8, 10, 12, 14, 17, 19, or 21 has can be implemented via software, or at least one of the functions can be implemented via hardware.

For example, the data process of controlling the sound volume of the sound produced by the sound producing unit 11 on the basis of the state information and the surroundings information about the vehicle which are acquired by the information acquiring unit 12, and outputting the sound having the sound volume to outside the vehicle, which is carried out by the control unit 13, can be implemented on a computer by using one or more programs. As an alternative, at least a part of the data process can be implemented via hardware.

### INDUSTRIAL APPLICABILITY

The sound output device for electric vehicle in accordance with the present invention notifies the approach of a vehicle to pedestrians and so on who are targets for notification by controlling the sound volume according to the state of the vehicle or the surroundings of the vehicle. Therefore, it is needless to say that the sound output device for electric vehicle in accordance with the present invention is used for electric vehicles. Furthermore, the sound output device for electric vehicle in accordance with the present invention is used for vehicles, such as hybrid cars, which use motors which produce less sound than engines as a travel driving source. The sound output device for electric vehicle provides remarkable advantages.

1. A sound output device for electric vehicle comprising:
a sound producing unit for producing a sound;
an information acquiring unit for acquiring state information about a state of a vehicle or surroundings information about surroundings of the vehicle; and
a control unit for controlling a sound volume and an output direction of the sound produced by said sound producing unit according to the state information or the surroundings information about the vehicle acquired by said information acquiring unit to output the sound to outside the vehicle.

2. The sound output device for electric vehicle according to claim 1, wherein said sound producing unit can change a tone of the sound produced thereby according to specified vehicle information.

3. The sound output device for electric vehicle according to claim 1, wherein when an outside noise acquired by said information acquiring unit has a level falling within a range from a preset lower limit threshold to a preset upper limit threshold, said control unit controls said sound volume in such a way that said sound volume increases every time when said outside noise increases in level, and otherwise controls said sound volume in such a way that said sound volume is kept constant.

4. The sound output device for electric vehicle according to claim 1, wherein said control unit controls said sound volume according to both information about a current position of said vehicle and map information which are acquired by said information acquiring unit.

5. The sound output device for electric vehicle according to claim 1, wherein said control unit controls said sound volume according to current time information acquired by said information acquiring unit.

6. The sound output device for electric vehicle according to claim 1, wherein said control unit detects an approach of a target for notification from a shot image acquired by said information acquiring unit to control said sound volume.

7. The sound output device for electric vehicle according to claim 1, wherein said control unit detects an approach of a target for notification from a distance to said target which is acquired by said information acquiring unit to control said sound volume.

8. The sound output device for electric vehicle according to claim 1, wherein said control unit controls said sound volume according to information showing whether or not a light stays illuminated which is acquired by said information acquiring unit.

9. The sound output device for electric vehicle according to claim 1, wherein said control unit controls said sound volume according to information about an operating state of a wiper which is acquired by said information acquiring unit.

10. The sound output device for electric vehicle according to claim 1, wherein said control unit controls the output direction of the sound produced by said sound producing unit according to both information about a current position of the vehicle and map information which are acquired by said information acquiring unit.

11. The sound output device for electric vehicle according to claim 1, wherein said control unit controls the output direction of said sound according to a shot image of an area surrounding the vehicle which is acquired by said information acquiring unit.

12. The sound output device for electric vehicle according to claim 1, wherein said control unit controls the output direction of said sound according to distance information about a distance to a target for notification which is acquired by said information acquiring unit.

13. The sound output device for electric vehicle according to claim 1, wherein said control unit controls the sound volume or the output direction of the sound produced by said sound producing unit according to a combination of two or more of current position information, map information, a shot image, a distance to a target for notification, information showing whether or not a light stays illuminated, information showing an operating state of a wiper, and information showing whether or not there is an approach of a target for notification which are acquired by said information acquiring unit.
